(19) United States
(12) Patent Application Publication
(10) Pub. No.: US 2026/0195092 A1
(43) Pub. Date: Jul. 9, 2026

(54) HEARABLE INTERFACES

(71) Applicant: Neurable Inc., Boston, MA (US)

(72) Inventor: Ramses Eduardo Alcaide, Boston, MA (US)

(21) Appl. No.: 19/441,816

(22) Filed: Jan. 6, 2026

Related U.S. Application Data
(60) Provisional application No. 63/742,417, filed on Jan. 6, 2025.

(51) Int. Cl. G06F 3/16; G06F 3/01; H04R 1/10; H04R 3/12

(52) U.S. Cl. CPC G06F 3/167; G06F 3/017; H04R 1/1041; H04R 1/1091; H04R 3/12

(57) ABSTRACT

Systems and methods for implementing hearable interfaces are described. For example, a method may include playing multiple sounds corresponding to respective menu options on at least one of a left speaker of headphones and a right speaker of the headphones using a spatial audio algorithm to simulate a distinct respective direction of arrival for each of the multiple sounds; detecting a motion of the headphones using one or more motion sensors; and selecting one of the respective menu options based on comparison of a direction of the motion of the headphones to respective directions of arrival of the multiple sounds corresponding to the respective menu options.

### CROSS REFERENCE TO RELATED APPLICATION(S

This application claims the benefit of U.S. Provisional Patent Application No. 63/742,417 filed on January 6, 2025, the contents of which are incorporated by reference herein.

### TECHNICAL FIELD

This disclosure relates to hearable interfaces.

### BACKGROUND

A brain–computer interface (BCI) is a direct communication link between the brain's electrical activity and an external device, most commonly a computer or robotic limb. BCIs are often directed at researching, mapping, assisting, augmenting, or repairing human cognitive or sensory-motor functions. BCI implementations range from non-invasive (e.g., using Electroencephalography (EEG), Magnetoencephalography (MEG), or Magnetic resonance imaging (MRI)) and partially invasive (e.g., using Electrocorticography (ECoG) or endovascular) to invasive (e.g., using a microelectrode array), based on how physically close electrodes are to brain tissue.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-E are illustrations of an example of a system including an in-ear brain-computer interface with a single eartip.

FIGS. 2A-E are illustrations of an example of a system including an in-ear brain-computer interface with two eartips and one electroencephalography channel per ear.

FIGS. 3A-E are illustrations of an example of a system including an in-ear brain-computer interface with two eartips and two electroencephalography channels per ear.

FIGS. 4A-E are illustrations of an example of an eartip with four electrodes.

FIGS. 5A-C are illustrations of an example of a system including an in-ear brain-computer interface with wireless earbud devices in communication with a smart charging case.

FIG. 6A is a block diagram of an example of a system including an in-ear brain-computer interface.

FIG. 6B is a block diagram of an example of a system including an in-ear brain-computer interface.

FIG. 7 is flowchart of an example of a technique for providing an in-ear brain-computer interface.

FIG. 8 is flowchart of an example of a technique for suppressing common mode noise in one or more electroencephalography channels of an in-ear brain-computer interface.

FIG. 9 is flowchart of an example of a technique for adding an additional electroencephalography channel in an in-ear brain-computer interface.

FIG. 10 is flowchart of an example of a technique for identifying artifacts in an electroencephalography signal caused by motion of an eartip using a contact microphone.

FIG. 11 is flowchart of an example of a technique for identifying artifacts in an electroencephalography signal caused by motion of an eartip using an accelerometer.

FIG. 12 is flowchart of an example of a technique for identifying artifacts in an electroencephalography signal caused by motion of an eartip using a gyroscope.

FIG. 13 is a signal flow diagram of an example of a signal flow in an in-ear brain-computer interface.

FIG. 14 is a signal flow diagram of an example of an electroencephalography signal processing pipeline in an in-ear brain-computer interface.

FIG. 15A is a block diagram of an example of a system including a hearable interface.

FIGS. 15B-E are illustrations of an example of an over-ear headphones that may be used to provide a hearable interface.

FIG. 16 is flowchart of an example of a technique for providing a hearable interface.

FIG. 17 is flowchart of an example of a technique for providing a hearable interface.

FIG. 18 is flowchart of an example of a technique for providing a hearable interface using electromyography signals.

FIG. 19 is flowchart of an example of a technique for providing a hearable interface using electromyography signals.

FIG. 20 is flowchart of an example of a technique for providing a hearable interface using electroencephalography signals.

FIG. 21 is flowchart of an example of a technique for providing a hearable interface using electroencephalography signals.

FIG. 22 is flowchart of an example of a technique for providing a hearable interface using P300 waveforms detected in electroencephalography signals.

FIG. 23 is flowchart of an example of a technique for providing a hearable interface using P300 waveforms detected in electroencephalography signals.

FIG. 24 is flowchart of an example of a technique for responding to a received message using a hearable interface.

### DETAILED DESCRIPTION

Systems and methods for providing hearable interfaces using various kinds of headphones are disclosed. For example, a system may include headphones configured to position a left speaker near a left ear and a right speaker near a right ear when worn by a human. The left speaker and/or the right speaker may be used to present audio output to a human user wearing the headphones, which may include multiple sounds corresponding to respective menu options of a hearable interface. In some implementations, a spatial audio algorithm may be used to simulate a distinct respective direction of arrival for each of the multiple sounds. The directions of arrival for each sound may serve as an implicit pointer to that menu option, which a user can then use to select that menu option by gesturing and or thinking about a gesture in approximately the same direction. In an example, where a menu includes just two options, each of the two options may be associated exclusively with the user’s left side/ear or right side/ear by playing its corresponding sound exclusively in a left speaker or a right speaker of the headphones. The headphones may also include various sensors that may be used to detect control input signals from a human user wearing the headphones, such as, for example, an inertial measurement unit (e.g., including an accelerometer and/or a gyroscope), which may be used to detect motions of the headphones, and/or a set of electrodes attached to the headphones, which may be used to detect electromyography (EMG) signals and/or electroencephalography (EEG) signals. The headphones may be configured to position the set of electrodes on a head of the human (e.g., positioned around the ears and/or in the ear canals of the human. In some implementations, these control input signals from a human user wearing the headphones may be used to select respective menu options of a hearable interface. For example, a physical gesture and/or a thought about a physical gesture may be mapped to a direction relative to the user’s body and/or to relative to the headphones. The menu option with a direction of arrival or an assigned speaker that best matches the direction of the gesture may be selected as the user’s choice from the audio menu.

For example, these techniques may be used to facilitate quick responses to incoming messages (e.g., text messages or emails) while a user is wearing the headphones, but does not necessarily have a view of screen on which the message may be displayed. In some implementations, a received message is played for a user through the headphones and then a binary menu asking the user if they wish to reply to the message (yes or no) is presented to the user in a hearable interface, where each option in the menu has a corresponding sound that is associated with an individual playout speaker and/or with a perceived direction of arrival. If the user selects yes from the menu by gesturing in a direction associated with the individual playout speaker and/or with a perceived direction of arrival for the yes option, then speech recognition interface for composing a responsive message may be opened. In some implementations, a large language model may be used to suggest proposed responses to the message, and these proposed responses may be presented to the user for potential selection in another menu of the hearable interface. In some implementations, a binary menu asking whether to reply or not may be skipped and proposed responses generated by a large language model may be presented by default, possibly in a menu with a no reply command as one of the menu options.

This hearable interface may provide advantages, such as enabling a user to quickly navigate menus of options and quickly respond to messages without using a screen by using the headphones controlled with gestures and/or thoughts.

Systems and methods for providing in-ear brain-computer interfaces are disclosed. An arrangement of electrodes on eartip attachment to an earbud device may be used to position a first electrode, a second electrode and a third electrode in contact with an inside surface (i.e., skin) of an ear canal. Measurements of electrical potential of the first electrode, the second electrode, and the third electrode are processed to determine a reference signal based on measurements of electrical potential of the first electrode, determine a ground signal (e.g., an active ground signal) based on measurements of electrical potential of the second electrode, and determine a first electroencephalography signal based on measurements of electrical potential of the third electrode and based on the reference signal. A brain state may be estimated based on the first electroencephalography signal. For example, the estimated brain state may include a vector of features (e.g., power spectral density in alpha (8-12 Hz), beta (12-30 Hz), theta (4-8 Hz), gamma (30-100 Hz), and/or Delta (1-4 Hz) frequency ranges) determined based on the first electroencephalography signal and/or a vector of brain state predictions generated using machine learning models trained to output predictions correlated with certain aspects of a brain state (e.g., correlated with a level of focus, a level of attentiveness, a level of cognitive load, fatigue, or sleepiness) based on the a window of samples from the first electroencephalography signal and/or based on the vector of features.

Systems may include driven-right-leg (DRL) circuitry configured to apply a voltage signal to skin the ear canal via the second electrode to suppress common mode noise in the first electroencephalography signal.

Additional electrodes may be used to generate additional channels of electroencephalography data. One or more such additional electrodes may be positioned in contact with the skin of the ear canal. In some implementations, all electrodes used to measure electroencephalography signals that are in turn used to determine the estimate of brain state are exclusively positioned within the ear canal during operation of the in-ear brain computer interface. In other implementations, additional electrodes for measuring electroencephalography signals may be positioned elsewhere on the skin of the user.

As used herein, the term “circuitry” refers to an arrangement of electronic components (e.g., transistors, resistors, capacitors, and/or inductors) that is structured to implement one or more functions. For example, a circuitry may include one or more transistors interconnected to form logic gates that collectively implement a logical function.

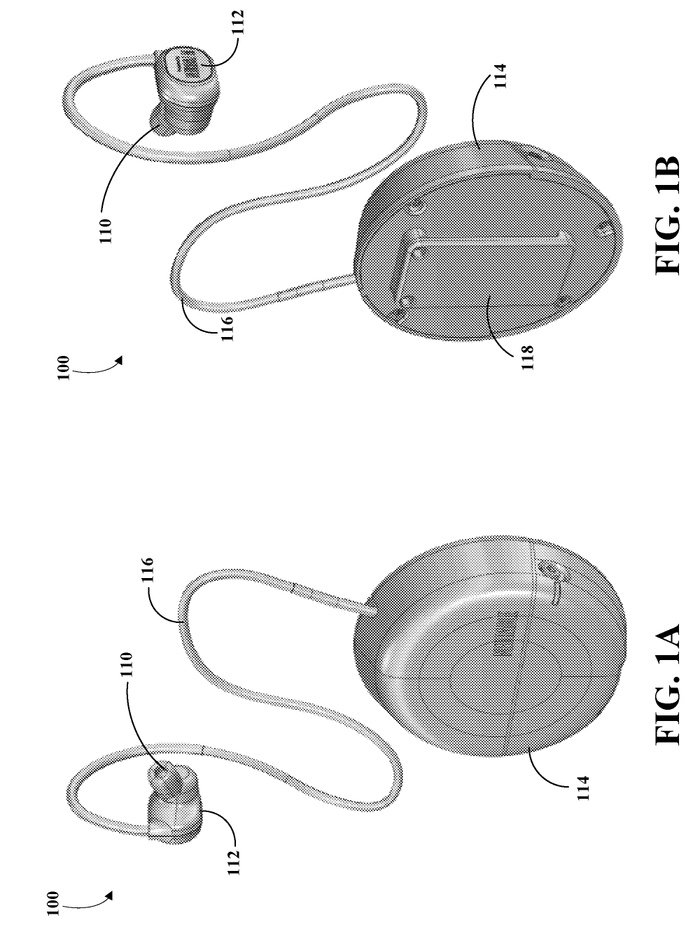

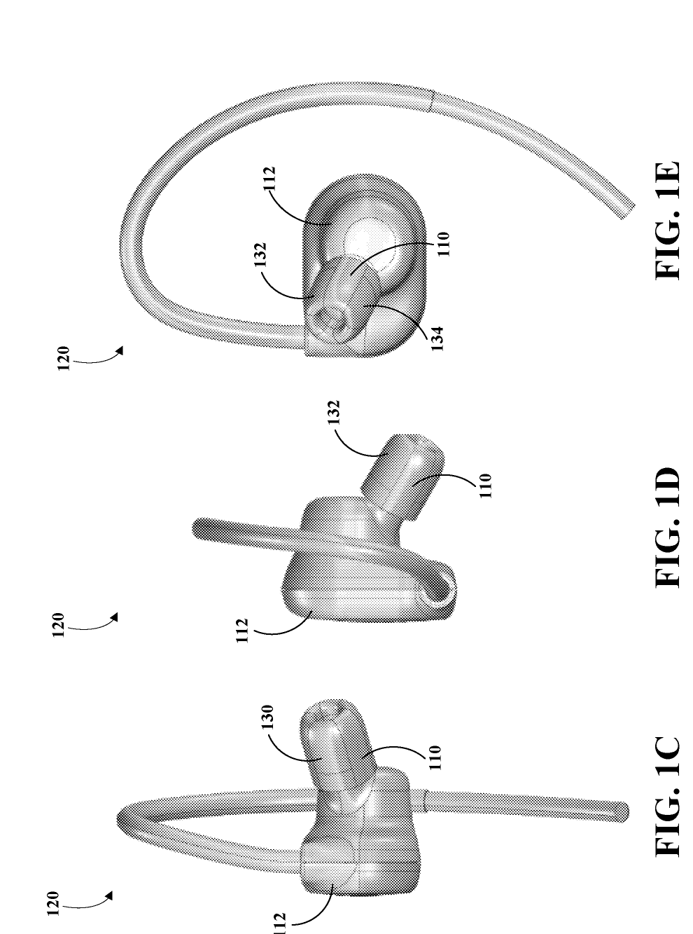

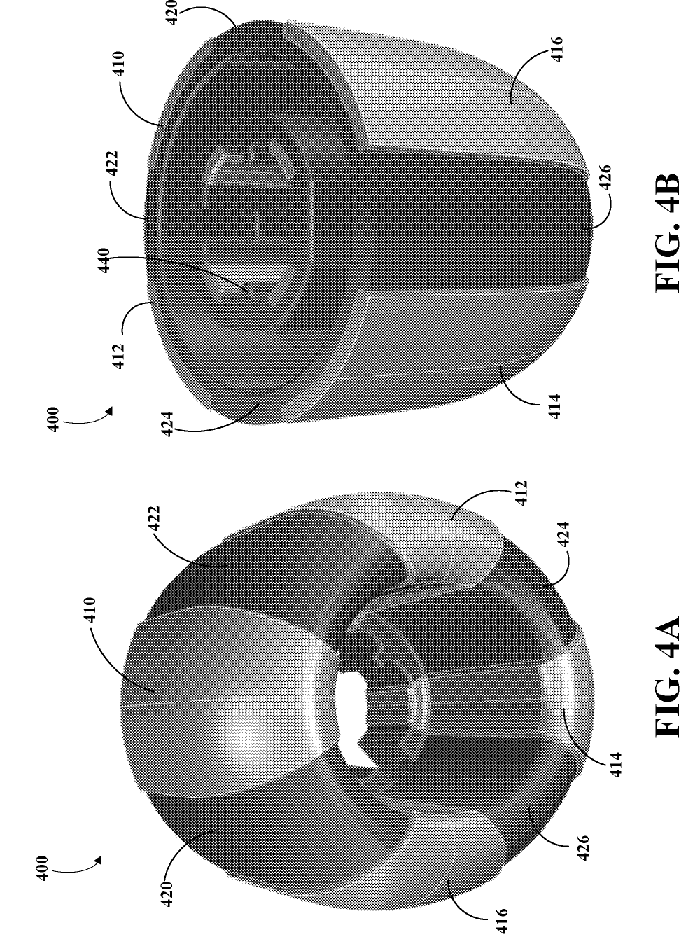

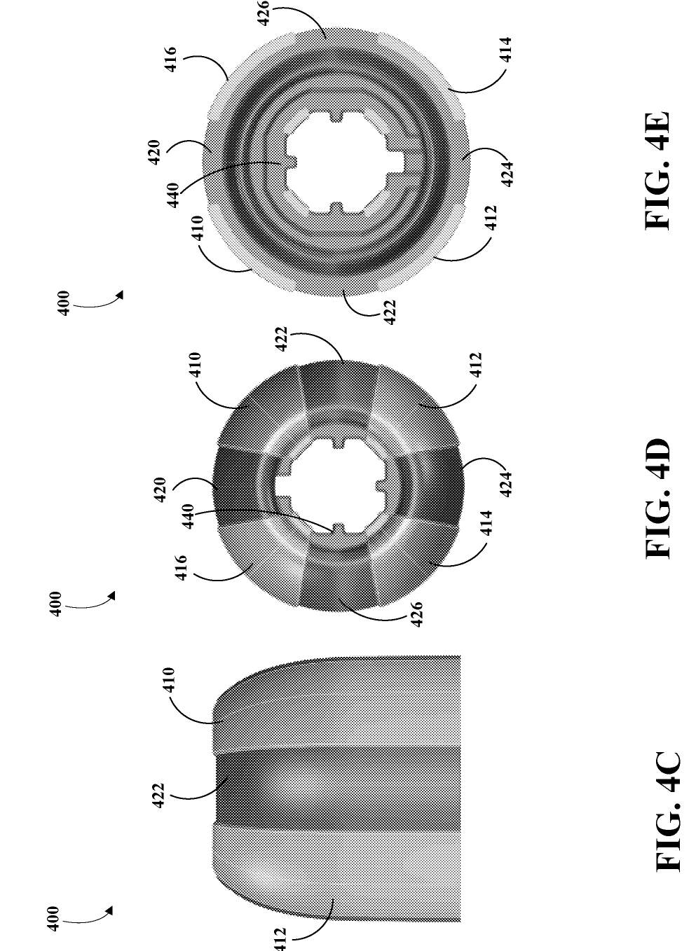

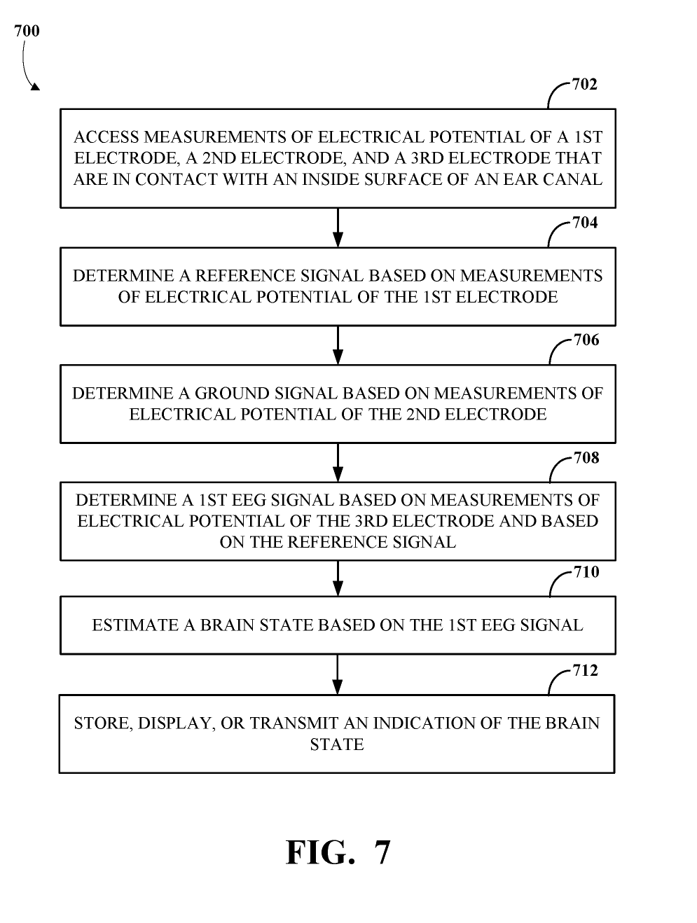

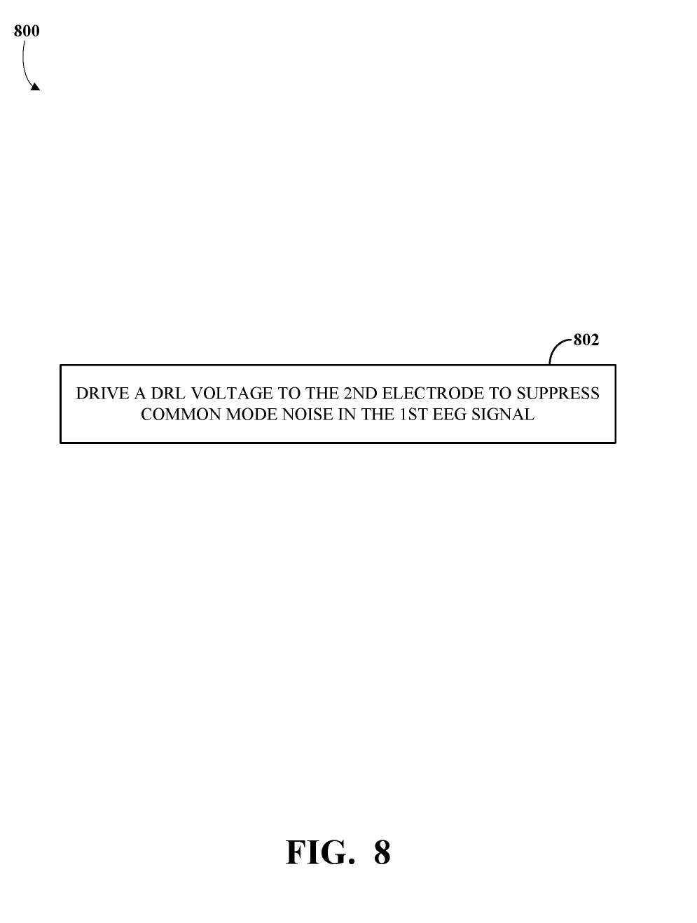

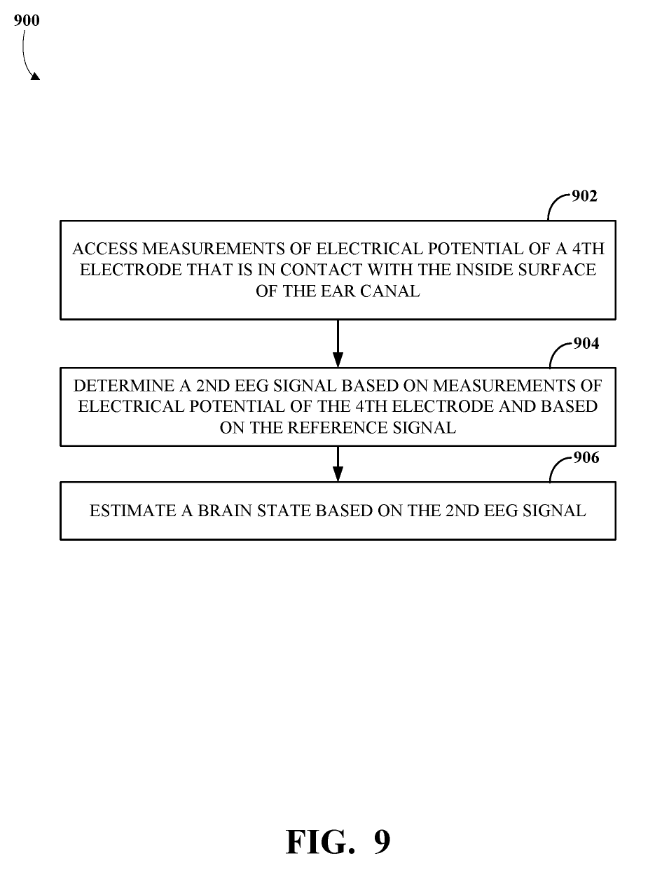

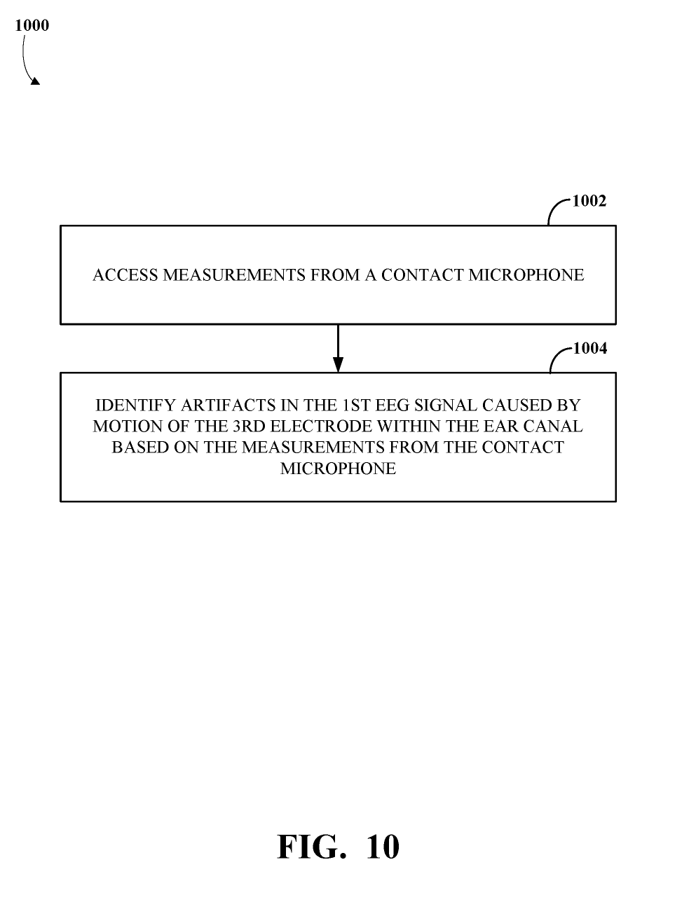

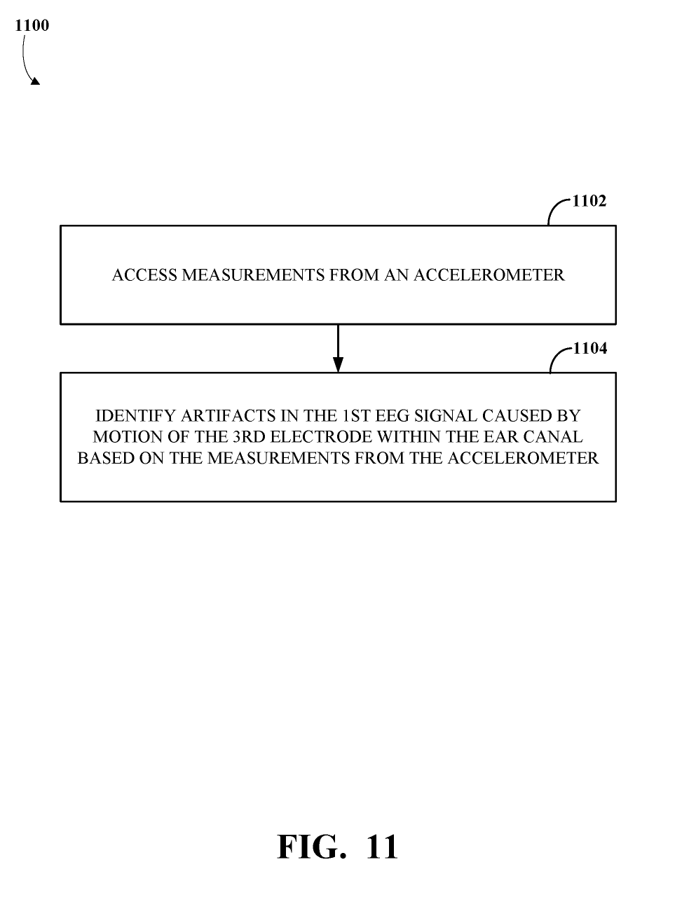

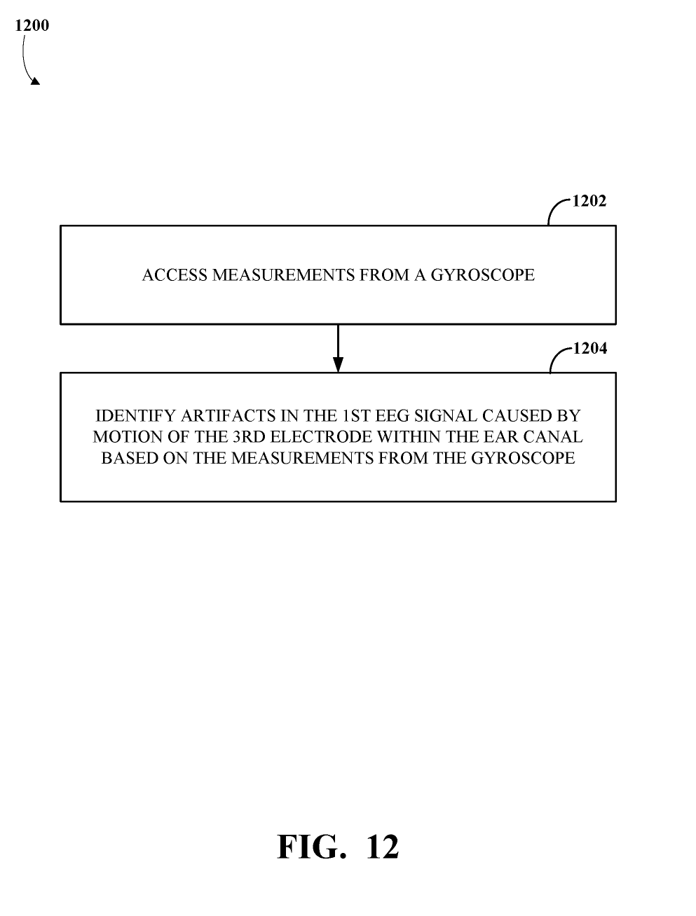

FIGS. 1A-E are illustrations of an example of a system 100 including an in-ear brain-computer interface with a single eartip. The system 100 includes an eartip 110 shaped for insertion in an ear canal. The system 100 includes three electrodes (e.g., a first electrode, a second electrode, and a third electrode) positioned on one or more outer surfaces of the eartip 110. For example, the eartip 110 may be similar in structure to the eartip 400 of FIGS. 4A-E. For example, these three electrodes may respectively be used as a common reference electrode, a ground/driven right leg (DRL) electrode, and a first electroencephalography channel electrode. Measurements of electrical potential of theses electrodes while the eartip 110 is inserted in an ear canal may be used to determine a reference signal, a ground signal, and a first electroencephalography signal. The first electroencephalography signal may be determined as a voltage relative to the reference signal. The first electroencephalography signal may be used to estimate a brain state (e.g., by generating a focus score or some other metric of brain waves detected in the first electroencephalography signal). For example, the system 100 may be used to implement the technique 700 of FIG. 7. For example, the system 100 may be used to implement the technique 800 of FIG. 8. For example, the system 100 may be used to implement the technique 900 of FIG. 9. For example, the system 100 may be used to implement the technique 1000 of FIG. 10. For example, the system 100 may be used to implement the technique 1100 of FIG. 11. For example, the system 100 may be used to implement the technique 1200 of FIG. 12.

The eartip 110 is attached to an earbud device 112 that includes a speaker (e.g., for playing music or other sounds for a user wearing the earbud device 112). The system 100 also includes a personal computing device 114 that is connected to the earbud device 112 via a cable 116. For example, the cable 116 may include conductors that may be used to transmit power from the personal computing device 114 to the earbud device 112 and/or to transmit data between the personal computing device 114 and the earbud device 112 (e.g., using a serial port communications protocol, such as Universal Serial Bus (USB), Inter-Integrated Circuit (I²C) or Serial Peripheral Interface (SPI)). In this example, the personal computing device 114 is a controller module that includes a clip 118 to facilitate a user wearing the personal computing device 114 (e.g., clipped to a belt or a pocket of their clothing). In some implementations, the earbud device 112 includes an array of microphones configured for use with the speaker to cancel noise.

FIGS. 1C-E are enlarged illustrations of components 120 of the system 100 from various perspectives, which include views of the three electrodes on an outer surface of the eartip 110. For example, the main body of the eartip 110 may be made of a flexible material that is an electrical insulator, such as, for example, silicone or rubber. The system 100 includes a first electrode 130 positioned on an outer surface of the eartip 110, a second electrode 132 positioned on an outer surface of the eartip 110, a third electrode 134 positioned on an outer surface of the eartip 110. In the example of FIGS. 1A-E, the three electrodes (130, 132, and 134) are all positioned on a same outer surface of the eartip 110, but in other examples, where an eartip includes multiple outer surfaces configured to come in contact with skin in an ear canal when the eartip 110 is inserted in the ear canal, the three electrodes (130, 132, and 134) may be positioned on different outer surfaces of the eartip 110. The first electrode 130, the second electrode 132, and the third electrode 134 may each include an electrically conductive strip and may be coated with a conductive polymer (e.g., polyacetylene or polypyrrole). For example, the first electrode 130, the second electrode 132, and the third electrode 134 may each include metal foil and/or conductive fabric.

In this example, the first electrode 130, the second electrode 132, and the third electrode 134 extend laterally along the eartip 110 from an anterior end of the eartip 110 that will be inserted deepest into the ear canal to a posterior end of the eartip 110. One or more of the electrodes (e.g., the third electrode 134) may be sized to fit entirely inside the ear canal. In this example, the eartip 110 has a cylindrical outer surface and the first electrode 130, the second electrode 132, and the third electrode 134 are positioned around the cylindrical outer surface with strips of insulator (e.g., strips of the main body of the eartip 110) on the cylindrical outer surface separating the first electrode 130, the second electrode 132, and the third electrode 134. In some implementations, an outer surface of the eartip 110 has an oval cross section perpendicular to axis of insertion into the ear canal. The eccentricity of the cross section of the eartip 110 may serve to fit more snugly in an ear canal and prevent or reduce rotation of the eartip 110 within the ear canal during use.

The eartip 110 may be an easily replaceable component of the earbud device 112. For example, system 100 may include multiple replaceable eartips of different sizes to better fit the ear canal of a particular user. In some implementations, the eartip 110 is removably attached to an earbud device 112 using a mechanical interface that includes a rotation locking mechanism configured to prevent rotation of the eartip 110 about an axis of insertion into the ear canal. This rotation locking mechanism may serve to prevent or reduce movement of the electrodes (130, 132, and 134) with respect to the electrical contacts on the earbud device 312 during use.

In some implementations, the system 100 includes circuitry configured to drive a driven right leg (DRL) voltage to the second electrode 132 to suppress common mode noise in the first electroencephalography signal. For example, circuitry configured to drive a DRL voltage on the second electrode 132 may be located in the earbud device 112 and/or may include logic or processor or microcontroller components located in the personal computing device 114.

The system 100 may also include one or more sensors for detecting motion of the earbud with respect to the ear canal during use that can cause artifacts in the first electroencephalography signal, which may enable the cancellation or suppression of these artifacts in the electroencephalography signal to improve signal to noise ratio (SNR) of the electroencephalography signal. For example, the system 100 may include a contact microphone positioned near an anterior end of the eartip 110 (e.g., positioned in the earbud device 112). For example, the system 100 may include an accelerometer positioned near an anterior end of the eartip 110 (e.g., positioned in the earbud device 112). For example, the system 100 may include a gyroscope (e.g., a microelectromechanical systems (MEMS) gyroscope) positioned near an anterior end of the eartip 110 (e.g., positioned in the earbud device 112).

In some implementations, the system uses only electrodes that are positioned inside an ear canal during use to detect electroencephalography signals used to estimate brain states and provide a brain-computer interface. For example, in some implementations, all electrodes on outer surfaces of the earbud device 112 are positioned on the eartip 110 to fit within the ear canal.

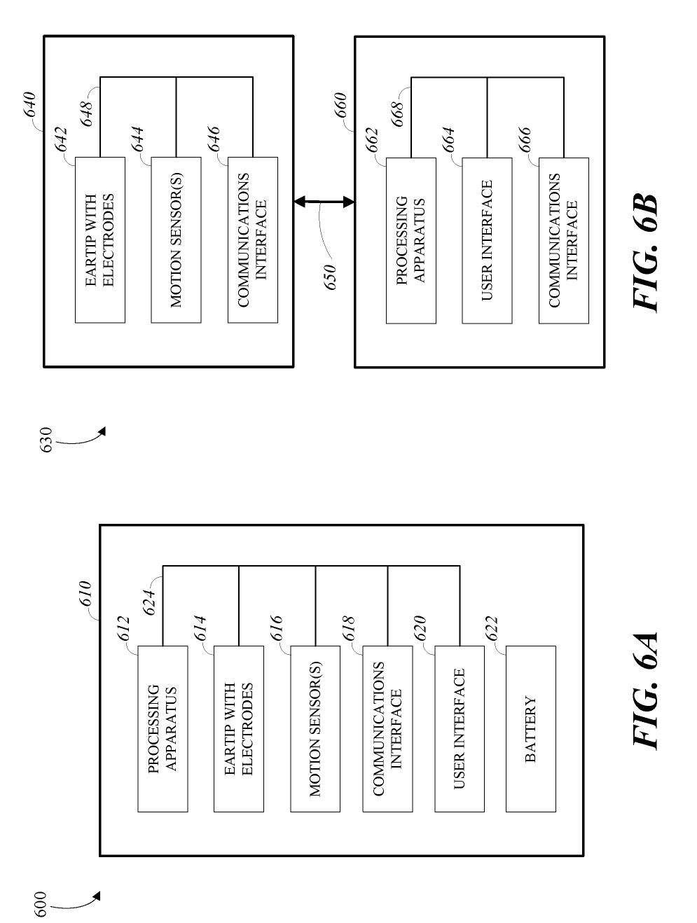

The system 100 includes a processing apparatus, which may be distributed between the personal computing device 114 and/or the earbud device 112. The processing apparatus may include one or more processors having single or multiple processing cores. The processing apparatus may include memory, such as random access memory device (RAM), flash memory, or any other suitable type of storage device such as a non-transitory computer readable memory. The memory of the processing apparatus may include executable instructions and data that can be accessed by one or more processors of the processing apparatus. For example, the processing apparatus may include the processing apparatus 612 of FIG. 6A. For example, the processing apparatus may include the processing apparatus 662 of FIG. 6B. In some implementations, the processing apparatus also includes one more processors (e.g., of a laptop computer or a cloud server) in communication with a processor of the personal computing device 114 via wireless network communication protocols (e.g., Bluetooth or WiFi). In some implementations, the electrodes (e.g., the third electrode 234) are connected to the processing apparatus via one or more conductors connected in series (e.g., including a conductor of the cable 116).

The processing apparatus of the system 100 may be configured to access measurements of electrical potential of the first electrode, the second electrode, and the third electrode; determine a reference signal based on measurements of electrical potential of the first electrode; determine a ground signal (e.g., an active ground signal) based on measurements of electrical potential of the second electrode; and determine a first electroencephalography signal based on measurements of electrical potential of the third electrode and based on the reference signal. The processing apparatus of the system 100 may be configured to estimate a brain state (e.g., a focus score) based on the first electroencephalography signal.

In some implementations, where the system 100 includes one or more sensors for detecting motion of the earbud with respect to the ear canal during use that can cause artifacts in the first electroencephalography signal, the processing apparatus may be configured to access measurements from a contact microphone, and identify artifacts in the first electroencephalography signal caused by motion of the eartip 110 within the ear canal based on the measurements from the contact microphone. For example, the processing apparatus may be configured to access measurements from an accelerometer, and identify artifacts in the first electroencephalography signal caused by motion of the eartip 110 within the ear canal based on the measurements from the accelerometer. For example, the processing apparatus may be configured to access measurements from a gyroscope, and identify artifacts in the first electroencephalography signal caused by motion of the eartip 110 within the ear canal based on the measurements from the gyroscope.

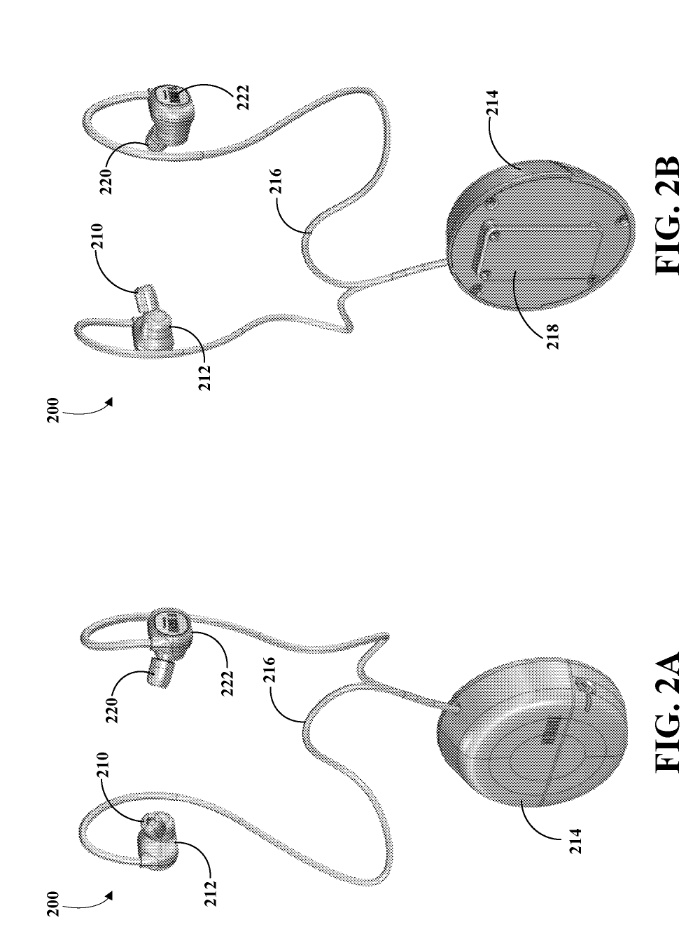

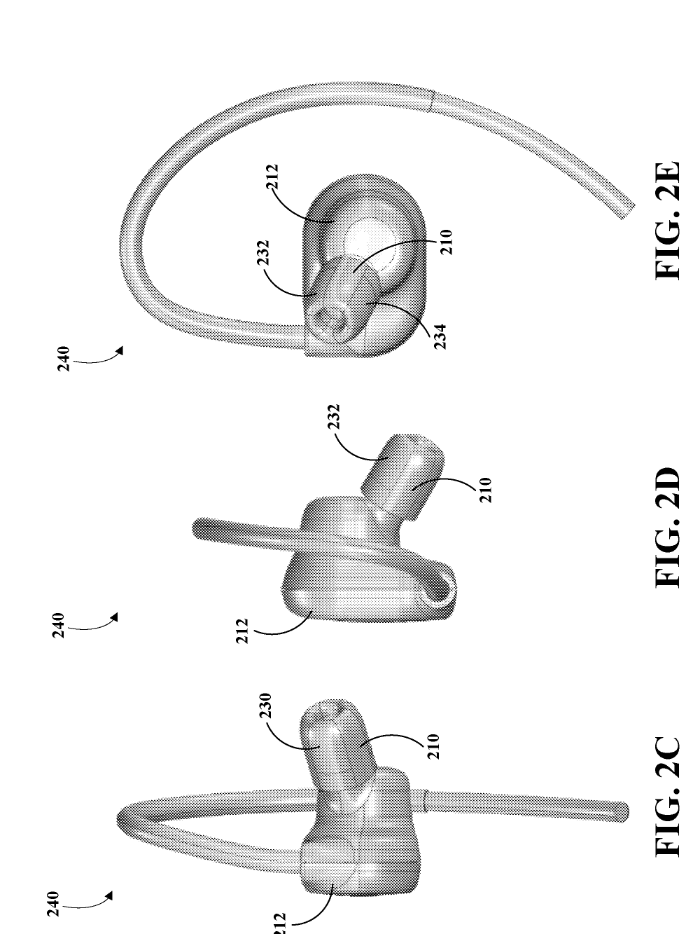

FIGS. 2A-E are illustrations of an example of a system 200 including an in-ear brain-computer interface with two eartips and one electroencephalography channel per ear. The system 200 includes a first eartip 210 shaped for insertion in an ear canal and a second eartip 220 shaped for insertion in an ear canal. The system 200 includes three electrodes (e.g., a first electrode, a second electrode, and a third electrode) positioned on one or more outer surfaces of the first eartip 210. For example, the first eartip 210 may be similar in structure to the eartip 400 of FIGS. 4A-E. The system 200 includes three electrodes (e.g., a fourth electrode, a fifth electrode, and a sixth electrode) positioned on one or more outer surfaces of the second eartip 220. For example, the second eartip 220 may be similar in structure to the eartip 400 of FIGS. 4A-E. For example, these three electrodes on each eartip may respectively be used as common reference electrode, a ground/driven right leg (DRL) electrode, and an electroencephalography channel electrode. Measurements of electrical potential of theses electrodes while the eartips 210 and 220 are inserted in their respective ear canals of a user may be used to determine a reference signal, a ground signal, and an electroencephalography signal from each ear. The electroencephalography signals may be determined as a voltage relative to their reference signals in the same ear canal. The electroencephalography signals may be used to estimate a brain state (e.g., by generating a focus score or some other metric of brain waves detected in the electroencephalography signals). For example, the system 200 may be used to implement the technique 700 of FIG. 7. For example, the system 200 may be used to implement the technique 800 of FIG. 8. For example, the system 200 may be used to implement the technique 900 of FIG. 9. For example, the system 200 may be used to implement the technique 1000 of FIG. 10. For example, the system 200 may be used to implement the technique 1100 of FIG. 11. For example, the system 200 may be used to implement the technique 1200 of FIG. 12.

The first eartip 210 is attached to a first earbud device 212 that includes a speaker (e.g., for playing music or other sounds for a user wearing the earbud device 212). The second eartip 220 is attached to a second earbud device 222 that includes a speaker. The system 200 also includes a personal computing device 214 that is connected to the earbud device 212 via a cable 216. For example, the cable 216 may include conductors that may be used to transmit power from the personal computing device 214 to the first earbud device 212 and the second earbud device 222, and/or used to transmit data between the personal computing device 214 and the first earbud device 212 and the second earbud device 222 (e.g., using a serial port communications protocol, such as Universal Serial Bus (USB), Inter-Integrated Circuit (I²C) or Serial Peripheral Interface (SPI)). In this example, the personal computing device 214 is a controller module that includes a clip 218 to facilitate a user wearing the personal computing device 214 (e.g., clipped to a belt or a pocket of their clothing). In some implementations, the first earbud device 212 and the second earbud device 222 include an array of microphones configured for use with the speakers to cancel noise.

FIGS. 2C-E are enlarged illustrations of components 240 of the system 200 from various perspectives, which include views of the three electrodes on an outer surface of the first eartip 210. For example, the main body of the first eartip 210 may be made of a flexible material that is an electrical insulator, such as, for example, silicone or rubber. The system 200 includes a first electrode 230 positioned on an outer surface of the first eartip 210, a second electrode 232 positioned on an outer surface of the first eartip 210, a third electrode 234 positioned on an outer surface of the first eartip 210. In the example of FIGS. 2A-E, the three electrodes (230, 232, and 234) are all positioned on a same outer surface of the first eartip 210, but in other examples, where an eartip includes multiple outer surfaces configured to come in contact with skin in an ear canal when the first eartip 210 is inserted in the ear canal, the three electrodes (230, 232, and 234) may be positioned on different outer surfaces of the first eartip 210. The first electrode 230, the second electrode 232, and the third electrode 234 may each include an electrically conductive strip and may be coated with a conductive polymer (e.g., polyacetylene or polypyrrole). For example, the first electrode 230, the second electrode 232, and the third electrode 234 may each include metal foil and/or conductive fabric.

In this example, the first electrode 230, the second electrode 232, and the third electrode 234 extend laterally along the first eartip 210 from an anterior end of the first eartip 210 that will be inserted deepest into the ear canal to a posterior end of the first eartip 210. One or more of the electrodes (e.g., the third electrode 234) may be sized to fit entirely inside the ear canal. In this example, the first eartip 210 has a cylindrical outer surface and the first electrode 230, the second electrode 232, and the third electrode 234 are positioned around the cylindrical outer surface with strips of insulator (e.g., strips of the main body of the first eartip 210) on the cylindrical outer surface separating the first electrode 230, the second electrode 232, and the third electrode 234. In some implementations, an outer surface of the first eartip 210 has an oval cross section perpendicular to axis of insertion into the ear canal. The eccentricity of the cross section of the first eartip 210 may serve to fit more snugly in an ear canal and prevent or reduce rotation of the first eartip 210 within the ear canal during use.

The first eartip 210 and the second eartip 220 may be an easily replaceable components of the first earbud device 212 and the second earbud device 222 respectively. For example, system 200 may include multiple replaceable eartips of different sizes to better fit the ear canal of a particular user. In some implementations, the first eartip 210 is removably attached to the first earbud device 212 using a mechanical interface that includes a rotation locking mechanism configured to prevent rotation of the first eartip 210 about an axis of insertion into the ear canal. This rotation locking mechanism may serve to prevent or reduce movement of the electrodes (230, 232, and 234) with respect to the electrical contacts on the earbud device 312 during use.

In some implementations, the system 200 includes circuitry configured to drive a driven right leg (DRL) voltage to the second electrode 232 to suppress common mode noise in the first electroencephalography signal. For example, circuitry configured to drive a DRL voltage on the second electrode 232 may be located in the first earbud device 212 and/or may include logic or processor or microcontroller components located in the personal computing device 214.

The system 200 may also include one or more sensors for detecting motion of the earbuds with respect to the ear canal they are in during use that can cause artifacts in the electroencephalography signals from the ear canals, which may enable the cancellation or suppression of these artifacts in the electroencephalography signals to improve signal to noise ratio (SNR) of the electroencephalography signals. For example, the system 200 may include a contact microphone positioned near an anterior end of the first eartip 210 (e.g., positioned in the first earbud device 212). For example, the system 200 may include an accelerometer positioned near an anterior end of the first eartip 210 (e.g., positioned in the first earbud device 212). For example, the system 200 may include a gyroscope (e.g., a microelectromechanical systems (MEMS) gyroscope) positioned near an anterior end of the first eartip 210 (e.g., positioned in the first earbud device 212).

In some implementations, the system uses only electrodes that are positioned inside an ear canal during use to detect electroencephalography signals used to estimate brain states and provide a brain-computer interface. For example, in some implementations, all electrodes on outer surfaces of the first earbud device 212 are positioned on the first eartip 210 to fit within an ear canal, and all electrodes on outer surfaces of the second earbud device 222 are positioned on the second eartip 220 to fit within a second ear canal.

The system 200 includes a processing apparatus, which may be distributed between the personal computing device 214 and/or the first earbud device 212 and the second earbud device 222. The processing apparatus may include one or more processors having single or multiple processing cores. The processing apparatus may include memory, such as random access memory device (RAM), flash memory, or any other suitable type of storage device such as a non-transitory computer readable memory. The memory of the processing apparatus may include executable instructions and data that can be accessed by one or more processors of the processing apparatus. For example, the processing apparatus may include the processing apparatus 612 of FIG. 6A. For example, the processing apparatus may include the processing apparatus 662 of FIG. 6B. In some implementations, the processing apparatus also includes one more processors (e.g., of a laptop computer or a cloud server) in communication with a processor of the personal computing device 214 via wireless network communication protocols (e.g., Bluetooth or WiFi). In some implementations, the electrodes (e.g., the third electrode 234) are connected to the processing apparatus via one or more conductors connected in series (e.g., including a conductor of the cable 216).

The processing apparatus of the system 200 may be configured to access measurements of electrical potential of the first electrode, the second electrode, and the third electrode; determine a reference signal based on measurements of electrical potential of the first electrode; determine a ground signal (e.g., an active ground signal) based on measurements of electrical potential of the second electrode; and determine a first electroencephalography signal based on measurements of electrical potential of the third electrode and based on the reference signal. The processing apparatus of the system 200 may be configured to estimate a brain state (e.g., a focus score) based on the first electroencephalography signal.

In some implementations, where the system 200 includes one or more sensors for detecting motion of the earbuds with respect to their respective ear canals during use that can cause artifacts in the electroencephalography signals, the processing apparatus may be configured to access measurements from a contact microphone, and identify artifacts in the first electroencephalography signal caused by motion of the first eartip 210 within the ear canal based on the measurements from the contact microphone. For example, the processing apparatus may be configured to access measurements from an accelerometer, and identify artifacts in the first electroencephalography signal caused by motion of the first eartip 210 within the ear canal based on the measurements from the accelerometer. For example, the processing apparatus may be configured to access measurements from a gyroscope, and identify artifacts in the first electroencephalography signal caused by motion of the first eartip 210 within the ear canal based on the measurements from the gyroscope.

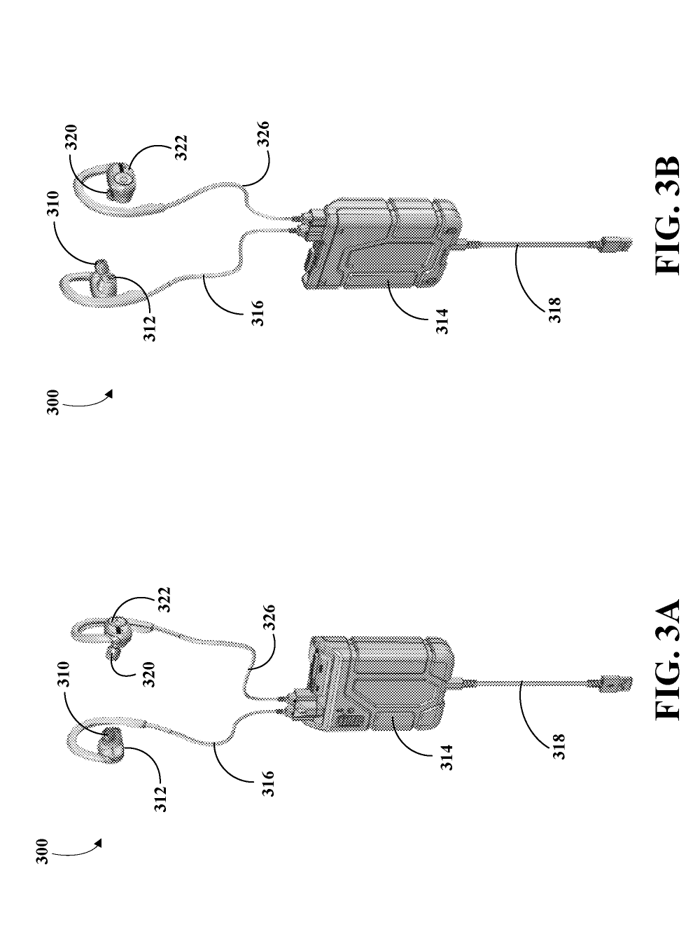

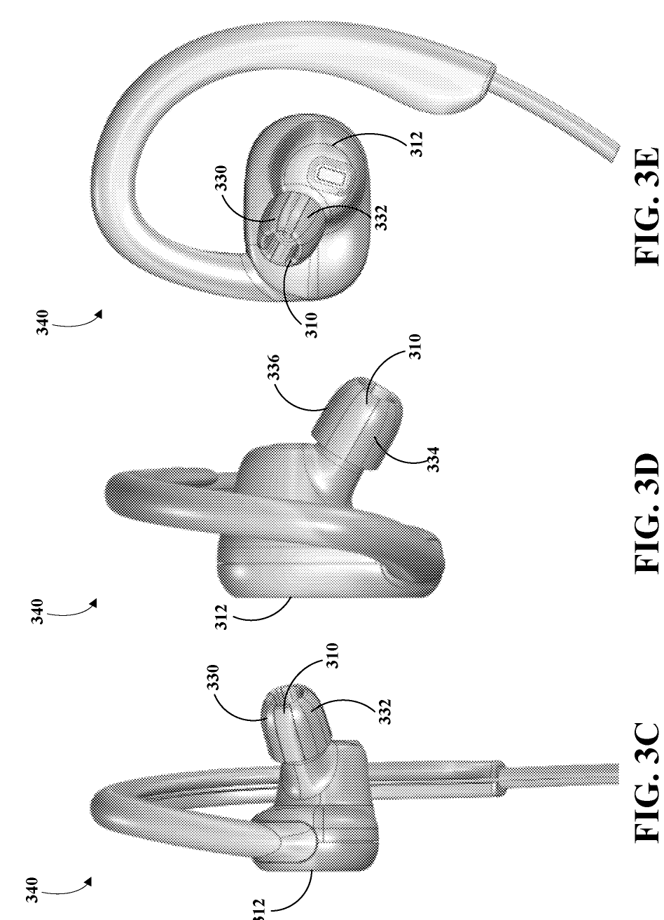

FIGS. 3A-E are illustrations of an example of a system 300 including an in-ear brain-computer interface with two eartips and two electroencephalography channels per ear. The system 300 includes a first eartip 310 shaped for insertion in an ear canal and a second eartip 320 shaped for insertion in an ear canal. The system 300 includes four electrodes (e.g., a first electrode, a second electrode, a third electrode and a fourth electrode) positioned on one or more outer surfaces of the first eartip 310. For example, the first eartip 310 may be the eartip 400 of FIGS. 4A-E. The system 300 includes four electrodes (e.g., a fifth electrode, a sixth electrode, a seventh electrode, and a sixth electrode) positioned on one or more outer surfaces of the second eartip 320. For example, the second eartip 320 may be the eartip 400 of FIGS. 4A-E. For example, these four electrodes on each eartip may respectively be used as common reference electrode, a ground/driven right leg (DRL) electrode, and two electroencephalography channel electrodes. Measurements of electrical potential of theses electrodes while the eartips 310 and 320 are inserted in their respective ear canals of a user may be used to determine a reference signal, a ground signal, and two electroencephalography signals from each ear. The electroencephalography signals may be determined as a voltage relative to their reference signals in the same ear canal. The electroencephalography signals may be used to estimate a brain state (e.g., by generating a focus score or some other metric of brain waves detected in the electroencephalography signals). For example, the system 300 may be used to implement the technique 700 of FIG. 7. For example, the system 300 may be used to implement the technique 800 of FIG. 8. For example, the system 300 may be used to implement the technique 900 of FIG. 9. For example, the system 300 may be used to implement the technique 1000 of FIG. 10. For example, the system 300 may be used to implement the technique 1100 of FIG. 11. For example, the system 300 may be used to implement the technique 1200 of FIG. 12.

The first eartip 310 is attached to a first earbud device 312 that includes a speaker (e.g., for playing music or other sounds for a user wearing the earbud device 312). The second eartip 320 is attached to a second earbud device 322 that includes a speaker. The system 300 also includes a personal computing device 314 that is connected to the first earbud device 312 via a cable 316. For example, the cable 316 may include conductors that may be used to transmit power from the personal computing device 314 to the first earbud device 312, and/or used to transmit data between the personal computing device 314 and the first earbud device 312 (e.g., using a serial port communications protocol, such as Universal Serial Bus (USB), Inter-Integrated Circuit (I²C) or Serial Peripheral Interface (SPI)). The system 300 also includes a cable 326 that connects the personal computing device 314 to the second earbud device 322. For example, the cable 326 may include conductors that may be used to transmit power from the personal computing device 314 to the second earbud device 322, and/or used to transmit data between the personal computing device 314 and the second earbud device 322. In this example, the personal computing device 314 is a controller module that includes a USB cable 318 to enable charging and/or communications with an additional computing device (e.g., a laptop). In some implementations, the first earbud device 312 and the second earbud device 322 include an array of microphones configured for use with the speakers to cancel noise.

FIGS. 3C-E are enlarged illustrations of components 340 of the system 300 from various perspectives, which include views of the four electrodes on an outer surface of the first eartip 310. For example, the main body of the first eartip 310 may be made of a flexible material that is an electrical insulator, such as, for example, silicone or rubber. The system 300 includes a first electrode 330 positioned on an outer surface of the first eartip 310, a second electrode 332 positioned on an outer surface of the first eartip 310, a third electrode 334 positioned on an outer surface of the first eartip 310, and a fourth electrode 336 positioned on an outer surface of the first eartip 310. In the example of FIGS. 3A-E, the four electrodes (330, 332, 334, and 336) are all positioned on a same outer surface of the first eartip 310, but in other examples, where an eartip includes multiple outer surfaces configured to come in contact with skin in an ear canal when the first eartip 310 is inserted in the ear canal, the four electrodes (330, 332, 334, and 336) may be positioned on different outer surfaces of the first eartip 310. The first electrode 330, the second electrode 332, the third electrode 334, and the fourth electrode 336 may each include an electrically conductive strip and may be coated with a conductive polymer (e.g., polyacetylene or polypyrrole). For example, the first electrode 330, the second electrode 332, the third electrode 334, and the fourth electrode 336 may each include metal foil and/or conductive fabric.

In this example, the first electrode 330, the second electrode 332, the third electrode 334, and the fourth electrode 336 extend laterally along the first eartip 310 from an anterior end of the first eartip 310 that will be inserted deepest into the ear canal to a posterior end of the first eartip 310. One or more of the electrodes (e.g., the third electrode 334) may be sized to fit entirely inside the ear canal. In this example, the first eartip 310 has a cylindrical outer surface and the first electrode 330, the second electrode 332, the third electrode 334, and the fourth electrode 336 are positioned around the cylindrical outer surface with strips of insulator (e.g., strips of the main body of the first eartip 310) on the cylindrical outer surface separating the first electrode 330, the second electrode 332, the third electrode 334, and the fourth electrode 336. In some implementations, an outer surface of the first eartip 310 has an oval cross section perpendicular to axis of insertion into the ear canal. The eccentricity of the cross section of the first eartip 310 may serve to fit more snugly in an ear canal and prevent or reduce rotation of the first eartip 310 within the ear canal during use.

The first eartip 310 and the second eartip 320 may be an easily replaceable components of the first earbud device 312 and the second earbud device 322 respectively. For example, system 300 may include multiple replaceable eartips of different sizes to better fit the ear canal of a particular user. In some implementations, the first eartip 310 is removably attached to the first earbud device 312 using a mechanical interface that includes a rotation locking mechanism configured to prevent rotation of the first eartip 310 about an axis of insertion into the ear canal. This rotation locking mechanism may serve to prevent or reduce movement of the electrodes (330, 332, 334, and 336) with respect to the electrical contacts on the earbud device 312 during use.

In some implementations, the system 300 includes circuitry configured to drive a driven right leg (DRL) voltage to the second electrode 332 to suppress common mode noise in the first electroencephalography signal. For example, circuitry configured to drive a DRL voltage on the second electrode 332 may be located in the first earbud device 312 and/or may include logic or processor or microcontroller components located in the personal computing device 314.

The system 300 may also include one or more sensors for detecting motion of the earbuds with respect to the ear canal they are in during use that can cause artifacts in the electroencephalography signals from the ear canals, which may enable the cancellation or suppression of these artifacts in the electroencephalography signals to improve signal to noise ratio (SNR) of the electroencephalography signals. For example, the system 300 may include a contact microphone positioned near an anterior end of the first eartip 310 (e.g., positioned in the first earbud device 312). For example, the system 300 may include an accelerometer positioned near an anterior end of the first eartip 310 (e.g., positioned in the first earbud device 312). For example, the system 300 may include a gyroscope (e.g., a microelectromechanical systems (MEMS) gyroscope) positioned near an anterior end of the first eartip 310 (e.g., positioned in the first earbud device 312).

In some implementations, the system uses only electrodes that are positioned inside an ear canal during use to detect electroencephalography signals used to estimate brain states and provide a brain-computer interface. For example, in some implementations, all electrodes on outer surfaces of the first earbud device 312 are positioned on the first eartip 310 to fit within an ear canal, and all electrodes on outer surfaces of the second earbud device 322 are positioned on the second eartip 320 to fit within a second ear canal.

The system 300 includes a processing apparatus, which may be distributed between the personal computing device 314 and/or the first earbud device 312 and the second earbud device 322. The processing apparatus may include one or more processors having single or multiple processing cores. The processing apparatus may include memory, such as random access memory device (RAM), flash memory, or any other suitable type of storage device such as a non-transitory computer readable memory. The memory of the processing apparatus may include executable instructions and data that can be accessed by one or more processors of the processing apparatus. For example, the processing apparatus may include the processing apparatus 612 of FIG. 6A. For example, the processing apparatus may include the processing apparatus 662 of FIG. 6B. In some implementations, the processing apparatus also includes one more processors (e.g., of a laptop computer or a cloud server) in communication with a processor of the personal computing device 314 via wireless network communication protocols (e.g., Bluetooth or WiFi). In some implementations, the electrodes (e.g., the third electrode 334) are connected to the processing apparatus via one or more conductors connected in series (e.g., including a conductor of the cable 316).

The processing apparatus of the system 300 may be configured to access measurements of electrical potential of the first electrode, the second electrode, and the third electrode; determine a reference signal based on measurements of electrical potential of the first electrode; determine a ground signal (e.g., an active ground signal) based on measurements of electrical potential of the second electrode; and determine a first electroencephalography signal based on measurements of electrical potential of the third electrode and based on the reference signal. The processing apparatus of the system 300 may be configured to estimate a brain state (e.g., a focus score) based on the first electroencephalography signal. For example, the processing apparatus may be configured to access measurements of electrical potential of the fourth electrode 336; determine a second electroencephalography signal based on measurements of electrical potential of the fourth electrode 336 and based on the reference signal; and estimate the brain state based on the second electroencephalography signal.

In some implementations, where the system 300 includes one or more sensors for detecting motion of the earbuds with respect to their respective ear canals during use that can cause artifacts in the electroencephalography signals, the processing apparatus may be configured to access measurements from a contact microphone, and identify artifacts in the first electroencephalography signal caused by motion of the first eartip 310 within the ear canal based on the measurements from the contact microphone. For example, the processing apparatus may be configured to access measurements from an accelerometer, and identify artifacts in the first electroencephalography signal caused by motion of the first eartip 310 within the ear canal based on the measurements from the accelerometer. For example, the processing apparatus may be configured to access measurements from a gyroscope, and identify artifacts in the first electroencephalography signal caused by motion of the first eartip 310 within the ear canal based on the measurements from the gyroscope.

FIGS. 4A-E are illustrations of an example of an eartip 400 with four electrodes. The eartip 400 may be shaped for insertion in an ear canal. The eartip 400 includes a first electrode 410 positioned on an outer surface of the eartip 400, a second electrode 412 positioned on an outer surface of the eartip 400, a third electrode 414 positioned on an outer surface of the eartip 400, and a fourth electrode 416 positioned on an outer surface of the eartip 400. These four electrodes are separated and electrically isolated from one another by strips of insulating material 420, 422, 424, and 426 (e.g., made of rubber or silicone).

The eartip 400 may be removably attached to an earbud device (e.g., the earbud device 112) using a mechanical interface 440 that includes a rotation locking mechanism configured to prevent rotation of the eartip 400 about an axis of insertion into the ear canal. This rotation locking mechanism (e.g., including one or notches or pegs) of the mechanical interface 440 may serve to prevent or reduce movement of the electrodes (410, 412, 414, and 416) with respect to electrical contacts on an earbud device 312 during use.

The first electrode 410, the second electrode 412, the third electrode 414 and the fourth electrode 416 extend laterally along the eartip from an anterior end of the eartip that will be inserted deepest into the ear canal to a posterior end of the eartip. In some implementations, the electrodes are sized such that their outer surfaces fit entirely inside the ear canal when the eartip 400 is inserted in the ear canal. In this example, the first electrode 410, the second electrode 412, the third electrode 414 and the fourth electrode 416 also extend laterally along an inner surface of the eartip to the mechanical interface 440 where the electrodes can make contact with corresponding electrical contact pads on an earbud device when the eartip 400 is attached to the earbud device. For example, the eartip 400 may have a cylindrical outer surface and the first electrode 410, the second electrode 412, and the third electrode 414, and the fourth electrode 416 may be positioned around the cylindrical outer surface with strips of insulating material 420, 422, 424, and 426 on the cylindrical outer surface separating the first electrode 410, the second electrode 412, and the third electrode 414, and the fourth electrode 416. In some implementations, an outer surface of the eartip 400 has an oval cross section perpendicular to axis of insertion into the ear canal. The eccentricity of the cross section of the eartip 400 may serve to fit more snugly in an ear canal and prevent or reduce rotation of the eartip 400 within the ear canal during use.

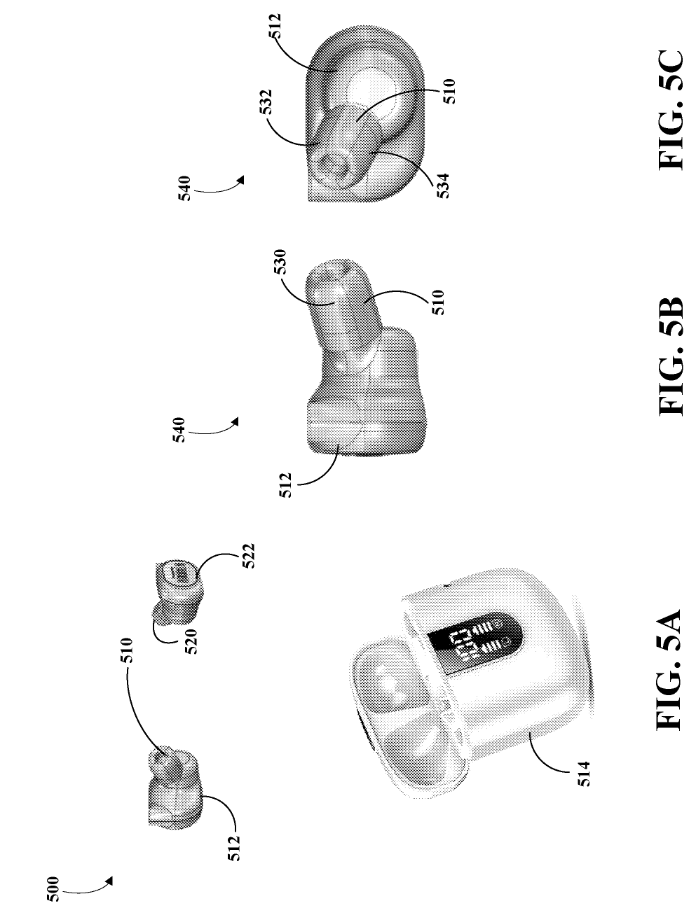

FIGS. 5A-C are illustrations of an example of a system 500 including in-ear brain-computer interface with wireless earbud devices in communication with a smart charging case. The system 500 includes a first eartip 510 shaped for insertion in an ear canal and a second eartip 520 shaped for insertion in an ear canal. The system 500 includes three electrodes (e.g., a first electrode, a second electrode, and a third electrode) positioned on one or more outer surfaces of the first eartip 510. For example, the first eartip 510 may be similar in structure to the eartip 400 of FIGS. 4A-E. The system 500 includes three electrodes (e.g., a fourth electrode, a fifth electrode, and a sixth electrode) positioned on one or more outer surfaces of the second eartip 520. For example, the second eartip 520 may be similar in structure to the eartip 400 of FIGS. 4A-E. For example, these three electrodes on each eartip may respectively be used as common reference electrode, a ground/driven right leg (DRL) electrode, and an electroencephalography channel electrode. Measurements of electrical potential of theses electrodes while the eartips 510 and 520 are inserted in their respective ear canals of a user may be used to determine a reference signal, a ground signal, and an electroencephalography signal from each ear. The electroencephalography signals may be determined as a voltage relative to their reference signals in the same ear canal. The electroencephalography signals may be used to estimate a brain state (e.g., by generating a focus score or some other metric of brain waves detected in the electroencephalography signals). For example, the system 500 may be used to implement the technique 700 of FIG. 7. For example, the system 500 may be used to implement the technique 800 of FIG. 8. For example, the system 500 may be used to implement the technique 900 of FIG. 9. For example, the system 500 may be used to implement the technique 1000 of FIG. 10. For example, the system 500 may be used to implement the technique 1100 of FIG. 11. For example, the system 500 may be used to implement the technique 1200 of FIG. 12.

The first eartip 510 is attached to a first earbud device 512 that includes a speaker (e.g., for playing music or other sounds for a user wearing the earbud device 512). The second eartip 520 is attached to a second earbud device 522 that includes a speaker. The system 500 also includes a personal computing device 514 that is configured to communicate with the earbud device 512 via a wireless communications link (e.g., a Bluetooth link). For example, measurements of electrical potential of the first electrode 530, the second electrode 532, and the third electrode 534 that are in contact with an inside surface of an ear canal may be amplified and converted to digital samples in the earbud device 512 before be transmitted to a processor in the personal computing device 514 via the wireless communications link. In this example, the personal computing device 514 is a smart charging case that includes battery and a compartment that is fitted to the first earbud device 512 and the second earbud device 522 and can be used to charge batteries in the first earbud device 512 and the second earbud device 522 when they are not in use. In some implementations, the first earbud device 512 and the second earbud device 522 include an array of microphones configured for use with the speakers to cancel noise.

FIGS. 5B-C are enlarged illustrations of components 540 of the system 500 from various perspectives, which include views of the three electrodes on an outer surface of the first eartip 510. For example, the main body of the first eartip 510 may be made of a flexible material that is an electrical insulator, such as, for example, silicone or rubber. The system 500 includes a first electrode 530 positioned on an outer surface of the first eartip 510, a second electrode 532 positioned on an outer surface of the first eartip 510, a third electrode 534 positioned on an outer surface of the first eartip 510. In the example of FIGS. 5A-E, the three electrodes (530, 532, and 534) are all positioned on a same outer surface of the first eartip 510, but in other examples, where an eartip includes multiple outer surfaces configured to come in contact with skin in an ear canal when the first eartip 510 is inserted in the ear canal, the three electrodes (530, 532, and 534) may be positioned on different outer surfaces of the first eartip 510. The first electrode 530, the second electrode 532, and the third electrode 534 may each include an electrically conductive strip and may be coated with a conductive polymer (e.g., polyacetylene or polypyrrole). For example, the first electrode 530, the second electrode 532, and the third electrode 534 may each include metal foil and/or conductive fabric.

In this example, the first electrode 530, the second electrode 532, and the third electrode 534 extend laterally along the first eartip 510 from an anterior end of the first eartip 510 that will be inserted deepest into the ear canal to a posterior end of the first eartip 510. One or more of the electrodes (e.g., the third electrode 534) may be sized to fit entirely inside the ear canal. In this example, the first eartip 510 has a cylindrical outer surface and the first electrode 530, the second electrode 532, and the third electrode 534 are positioned around the cylindrical outer surface with strips of insulator (e.g., strips of the main body of the first eartip 510) on the cylindrical outer surface separating the first electrode 530, the second electrode 532, and the third electrode 534. In some implementations, an outer surface of the first eartip 510 has an oval cross section perpendicular to axis of insertion into the ear canal. The eccentricity of the cross section of the first eartip 510 may serve to fit more snugly in an ear canal and prevent or reduce rotation of the first eartip 510 within the ear canal during use.

The first eartip 510 and the second eartip 520 may be an easily replaceable components of the first earbud device 512 and the second earbud device 522 respectively. For example, system 500 may include multiple replaceable eartips of different sizes to better fit the ear canal of a particular user. In some implementations, the first eartip 510 is removably attached to the first earbud device 512 using a mechanical interface that includes a rotation locking mechanism configured to prevent rotation of the first eartip 510 about an axis of insertion into the ear canal. This rotation locking mechanism may serve to prevent or reduce movement of the electrodes (530, 532, and 534) with respect to the electrical contacts on the earbud device 312 during use.

In some implementations, the system 500 includes circuitry configured to drive a driven right leg (DRL) voltage to the second electrode 532 to suppress common mode noise in the first electroencephalography signal. For example, circuitry configured to drive a DRL voltage on the second electrode 532 may be located in the first earbud device 512 and/or may include logic or processor or microcontroller components located in the personal computing device 514.

The system 500 may also include one or more sensors for detecting motion of the earbuds with respect to the ear canal they are in during use that can cause artifacts in the electroencephalography signals from the ear canals, which may enable the cancellation or suppression of these artifacts in the electroencephalography signals to improve signal to noise ratio (SNR) of the electroencephalography signals. For example, the system 500 may include a contact microphone positioned near an anterior end of the first eartip 510 (e.g., positioned in the first earbud device 512). For example, the system 500 may include an accelerometer positioned near an anterior end of the first eartip 510 (e.g., positioned in the first earbud device 512). For example, the system 500 may include a gyroscope (e.g., a microelectromechanical systems (MEMS) gyroscope) positioned near an anterior end of the first eartip 510 (e.g., positioned in the first earbud device 512).

In some implementations, the system uses only electrodes that are positioned inside an ear canal during use to detect electroencephalography signals used to estimate brain states and provide a brain-computer interface. For example, in some implementations, all electrodes on outer surfaces of the first earbud device 512 are positioned on the first eartip 510 to fit within an ear canal, and all electrodes on outer surfaces of the second earbud device 522 are positioned on the second eartip 520 to fit within a second ear canal.

The system 500 includes a processing apparatus, which may be distributed between the personal computing device 514 and/or the first earbud device 512 and the second earbud device 522. The processing apparatus may include one or more processors having single or multiple processing cores. The processing apparatus may include memory, such as random access memory device (RAM), flash memory, or any other suitable type of storage device such as a non-transitory computer readable memory. The memory of the processing apparatus may include executable instructions and data that can be accessed by one or more processors of the processing apparatus. For example, the processing apparatus may include the processing apparatus 612 of FIG. 6A. For example, the processing apparatus may include the processing apparatus 662 of FIG. 6B. In some implementations, the processing apparatus also includes one more processors (e.g., of a laptop computer or a cloud server) in communication with a processor of the personal computing device 514 via wireless network communication protocols (e.g., Bluetooth or WiFi). In some implementations, the processing apparatus receives the measurements of electrical potential of the third electrode via a wireless communications link (e.g., a Bluetooth link).

The processing apparatus of the system 500 may be configured to access measurements of electrical potential of the first electrode, the second electrode, and the third electrode; determine a reference signal based on measurements of electrical potential of the first electrode; determine a ground signal (e.g., an active ground signal) based on measurements of electrical potential of the second electrode; and determine a first electroencephalography signal based on measurements of electrical potential of the third electrode and based on the reference signal. The processing apparatus of the system 500 may be configured to estimate a brain state (e.g., a focus score) based on the first electroencephalography signal.

In some implementations, where the system 500 includes one or more sensors for detecting motion of the earbuds with respect to their respective ear canals during use that can cause artifacts in the electroencephalography signals, the processing apparatus may be configured to access measurements from a contact microphone, and identify artifacts in the first electroencephalography signal caused by motion of the first eartip 510 within the ear canal based on the measurements from the contact microphone. For example, the processing apparatus may be configured to access measurements from an accelerometer, and identify artifacts in the first electroencephalography signal caused by motion of the first eartip 510 within the ear canal based on the measurements from the accelerometer. For example, the processing apparatus may be configured to access measurements from a gyroscope, and identify artifacts in the first electroencephalography signal caused by motion of the first eartip 510 within the ear canal based on the measurements from the gyroscope.

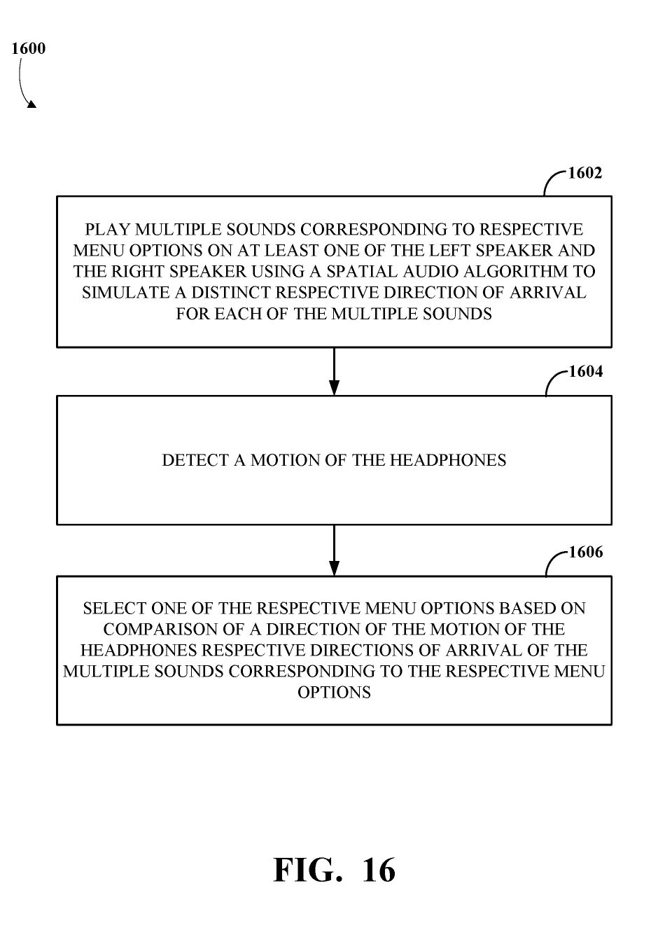

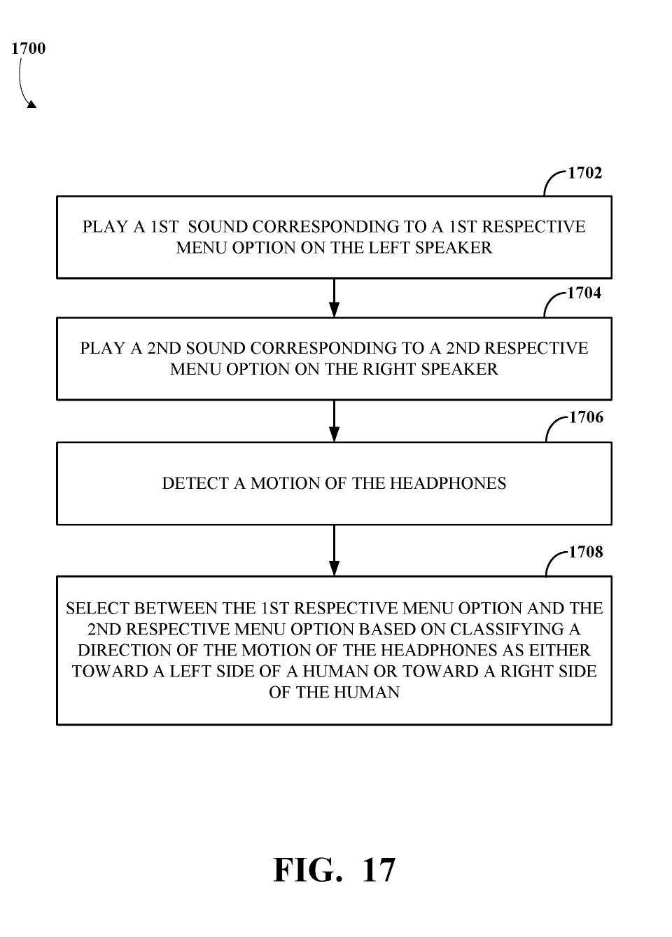

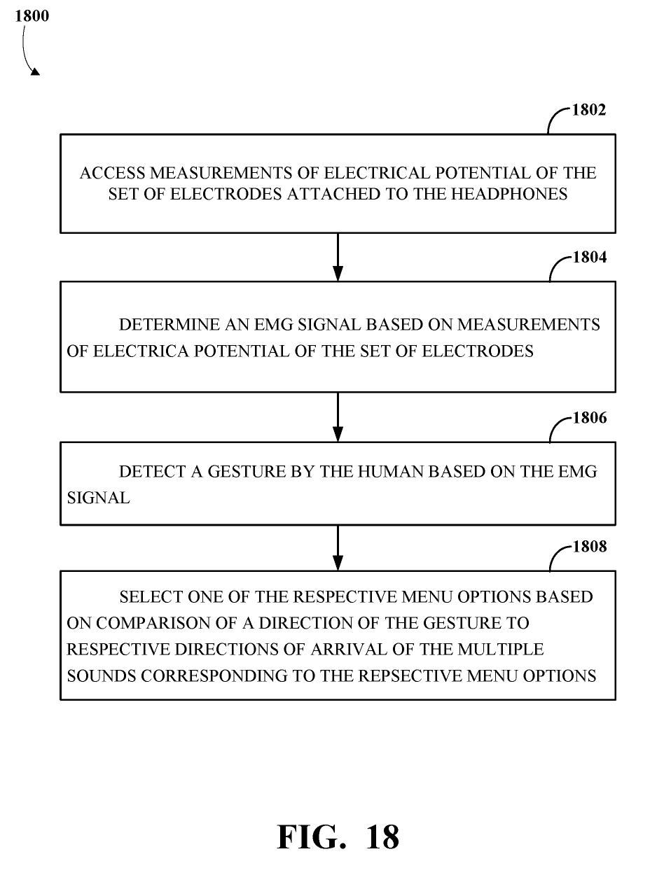

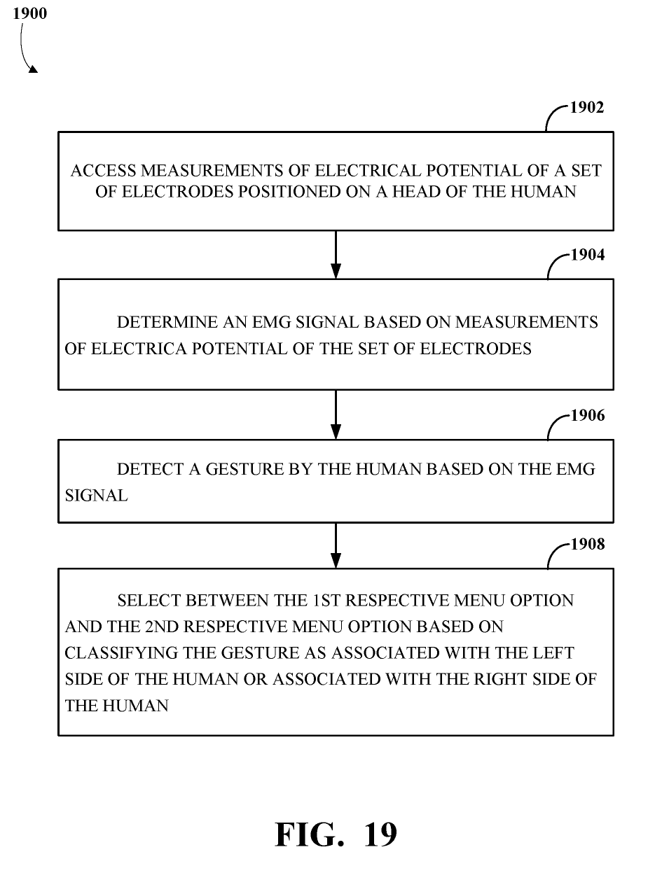

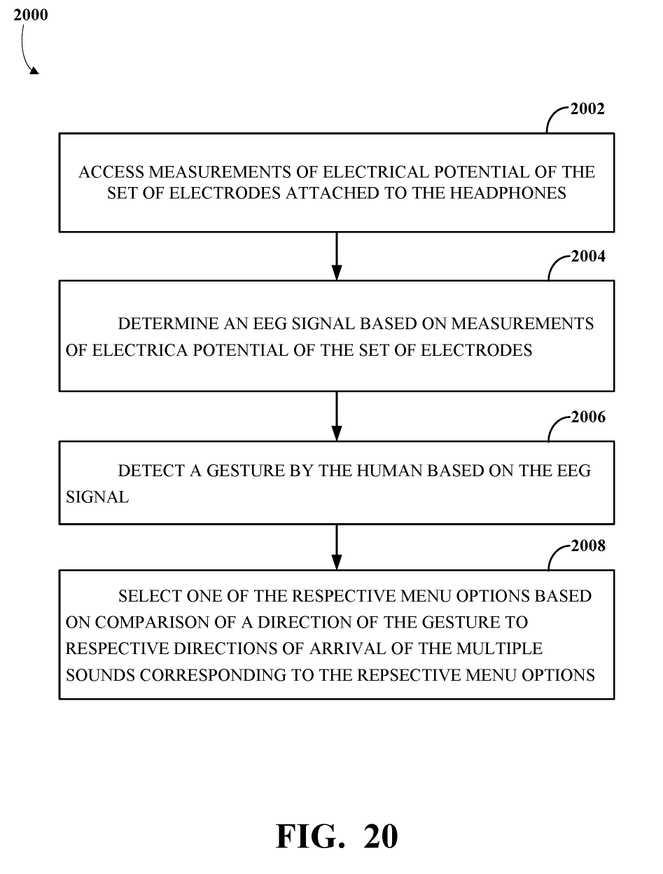

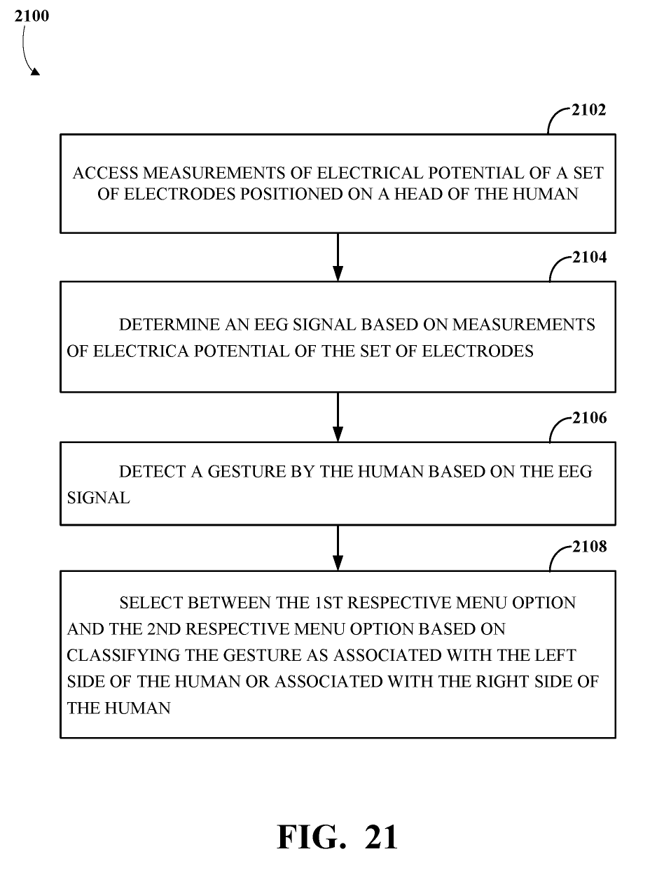

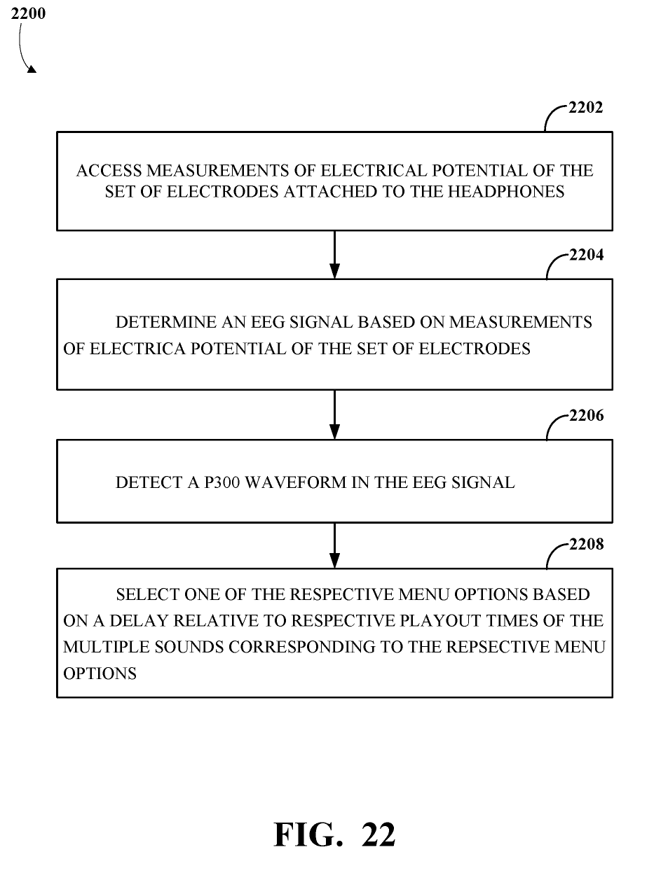

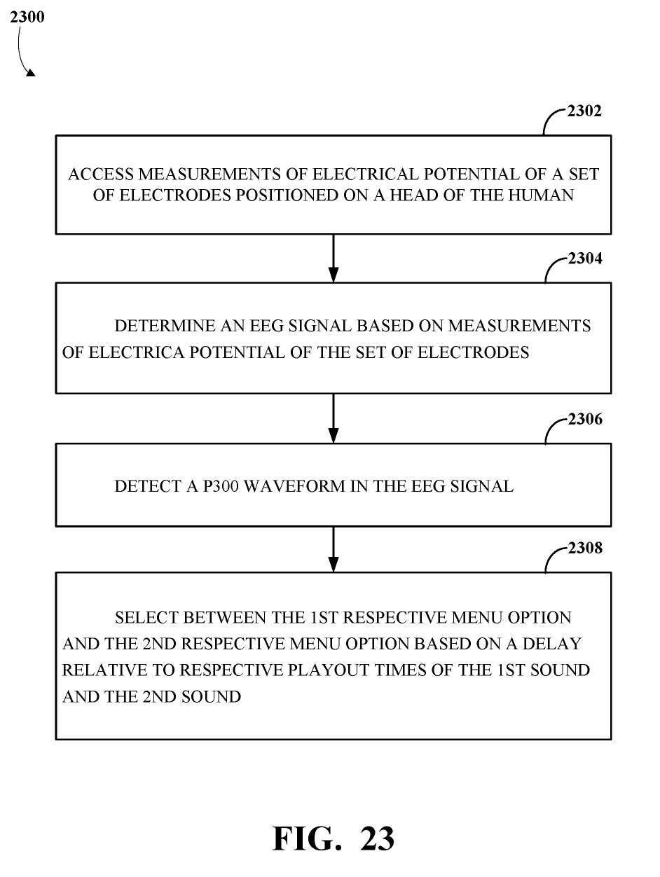

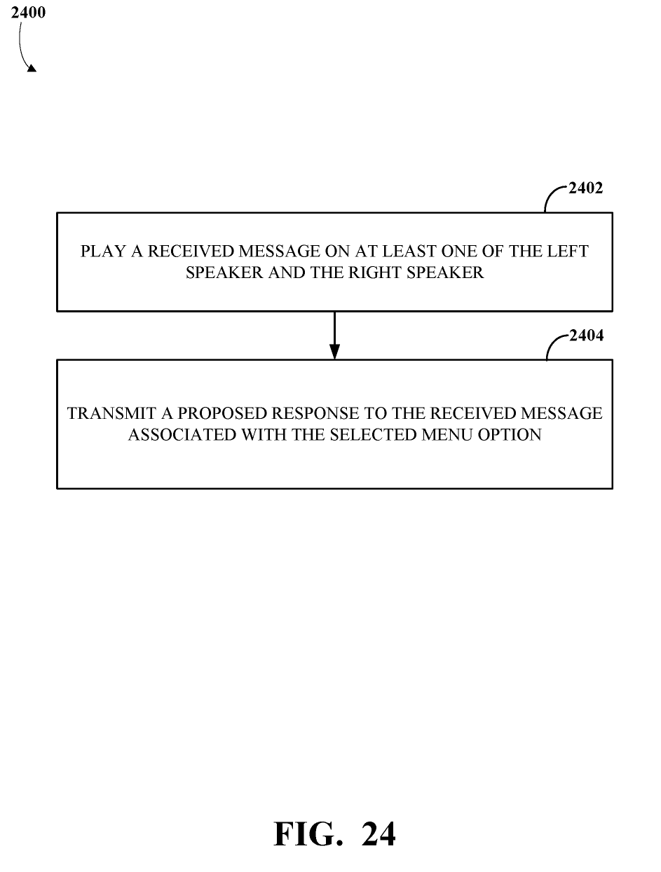

FIG. 6A is a block diagram of an example of a system 600 including an in-ear brain-computer interface. The system 600 includes a headset 610 including one or two earbud devices and/or a personal computing device. The headset 610 includes a processing apparatus 612, an eartip 614 with electrodes, one or more motion sensors 616, a communications interface 618, a user interface 620, and a battery 622. The components of the headset 610 may communicate with each other via a bus 624. The system 600 may be used to implement processes described in this disclosure, such as the technique 700 of FIG. 7, the technique 800 of FIG. 8, the technique 900 of FIG. 9, the technique 1000 of FIG. 10, the technique 1100 of FIG. 11, the technique 1200 of FIG. 12, the technique 1600 of FIG. 16, the technique 1700 of FIG. 17, the technique 1800 of FIG. 18, the technique 1900 of FIG. 19, the technique 2000 of FIG. 20, the technique 2100 of FIG. 21, the technique 2200 of FIG. 22, the technique 2300 of FIG. 23, and/or the technique 2400 of FIG. 24.

The headset 610 includes an eartip 614 (e.g., the eartip 110 or the eartip 400) with electrodes. The system 600 includes a first electrode positioned on an outer surface of the eartip 614, a second electrode positioned on an outer surface of the eartip 614, and a third electrode positioned on an outer surface of the eartip 614. In some implementations, the system 600 includes additional electrodes on the eartip 614. For example, the system 600 may include a fourth electrode (e.g., the fourth electrode 416) positioned on an outer surface of the eartip 614. The eartip 614 may be removably attached to an earbud device of the headset 610 and the eartip 614 may be shaped for insertion in an ear canal. The eartip 614 may be configured to position the first electrode, the second electrode and the third electrode in contact with an inside surface (i.e., skin) of an ear canal.

The headset 610 includes a processing apparatus 612. The processing apparatus 612 may include one or more processors having single or multiple processing cores. The processing apparatus 612 may include memory, such as random access memory device (RAM), flash memory, or any other suitable type of storage device such as a non-transitory computer readable memory. The memory of the processing apparatus 612 may include executable instructions and data that can be accessed by one or more processors of the processing apparatus 612. For example, the processing apparatus 612 may include one or more DRAM modules such as double data rate synchronous dynamic random-access memory (DDR SDRAM). In some implementations, the processing apparatus 612 may include a digital signal processor (DSP). In some implementations, the processing apparatus 612 may include an application specific integrated circuit (ASIC). For example, the processing apparatus 612 may include a custom vector processor for efficiently executing machine learning models at an inference phase. The processing apparatus 612 may be spatially distributed between components of the headset 610, such as personal computing device (e.g., the personal computing device 114, the personal computing device 214, or the personal computing device 314), a first earbud device (e.g., the first earbud device 112, the first earbud device 212, or the first earbud device 312), and/or a second earbud device (e.g., the second earbud device 222 or the second earbud device 322). For example, different components of the processing apparatus 612 may communicate with each other via one more serial port links (e.g., via conductors of the cable 116, the cable 216, the cable 316, or the cable 316) or via another communications protocol / network topology.

The processing apparatus 612 may be configured to access measurements of electrical potential of the first electrode, the second electrode, and the third electrode; determine a reference signal based on measurements of electrical potential of the first electrode; determine a ground signal based on measurements of electrical potential of the second electrode; determine a first electroencephalography signal based on measurements of electrical potential of the third electrode and based on the reference signal; and estimate a brain state based on the first electroencephalography signal. In some implementations, the eartip 614 includes a fourth electrode and the processing apparatus 612 is configured to access measurements of electrical potential of the fourth electrode; determine a second electroencephalography signal based on measurements of electrical potential of the fourth electrode and based on the reference signal; and estimate the brain state based on the second electroencephalography signal.

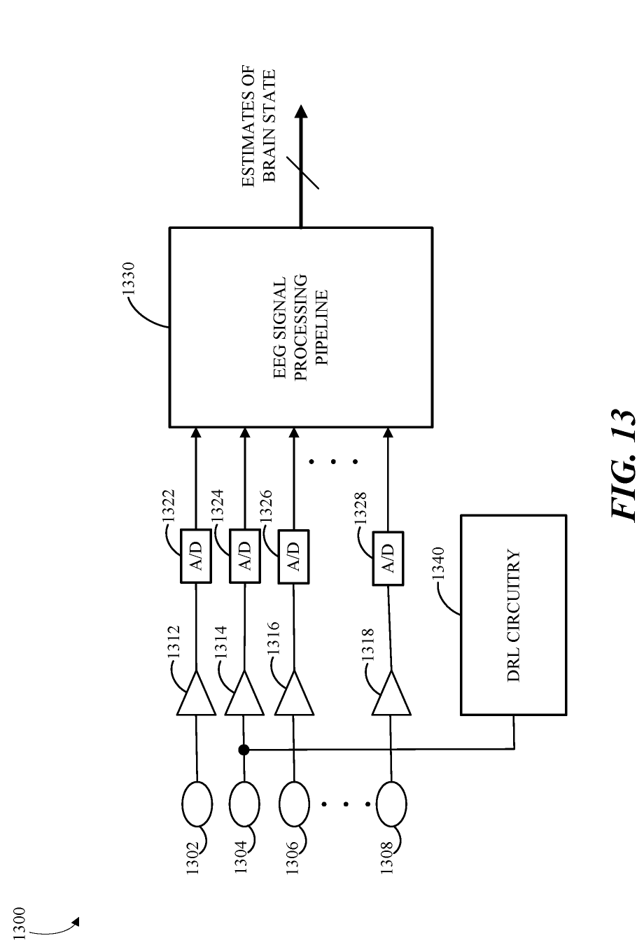

Although not explicitly shown in FIG. 6A, the headset 610 may include measurement circuitry configured to measure voltages at the electrodes on the eartip 614 and make those measurements accessible (e.g., directly or via the bus 624) to the processing apparatus 612. For example, the headset 610 may include circuitry depicted in the signal flow 1300 of FIG. 13 for amplifying and sampling the voltages at the electrodes on the eartip 614.

The headset 610 includes one or more motion sensors 616, which may be configured to detect motion of an earbud of the headset 610 with respect to an ear canal during use that can cause artifacts in an electroencephalography signal. For example, the one or more motion sensors 616 may include a contact sensor positioned near an anterior end of the eartip 614, an accelerometer, and/or a gyroscope. For example, the processing apparatus 612 may be configured to access measurements from a contact microphone, and identify artifacts in the first electroencephalography signal caused by motion of the eartip 614 within the ear canal based on the measurements from the contact microphone. For example, the processing apparatus may be configured to access measurements from an accelerometer, and identify artifacts in the first electroencephalography signal caused by motion of the eartip 614 within the ear canal based on the measurements from the accelerometer. For example, the processing apparatus may be configured to access measurements from a gyroscope, and identify artifacts in the first electroencephalography signal caused by motion of the eartip 614 within the ear canal based on the measurements from the gyroscope.

The headset 610 may include the communications interface 618, which may enable communications with a personal computing device (e.g., a smartphone, a tablet, or a laptop computer). For example, the communications interface 618 may be used to receive commands controlling operation of the and configuration of an in-ear brain-computer interface provided by the headset 610. For example, the communications interface 618 may be used to transfer data (e.g., including an indication of an estimated brain state and/or electroencephalography signals) from the brain-computer interface to a personal computing device. For example, the communications interface 618 may include a wired interface, such as a universal serial bus (USB) interface or a FireWire interface. For example, the communications interface 618 may include a wireless interface, such as a Bluetooth interface, a ZigBee interface, and/or a Wi-Fi interface.

The headset 610 may include a user interface 620. For example, the user interface 620 may include a speaker in an earbud device of the headset 610, which may be used to play audio signals, including audio prompts for a user. For example, the user interface 620 may include one or more microphones, which may configured accept audio signals and detect verbal commands from a user. For example, the user interface 620 may include an LCD display for presenting images and/or messages to a user. For example, the user interface 620 may include a button or switch enabling a person to manually turn the headset 610 on and off. For example, the user interface 620 may include a button or capacitive touch sensor for activating or deactivating the in-ear brain-computer interface.

The headset 610 may include the battery 622 that powers the headset 610 and/or its peripherals. For example, the battery 622 may be charged wirelessly or through a micro-USB interface.

FIG. 6B is a block diagram of an example of a system 630 including an in-ear brain-computer interface. The system 630 includes an earbud device 640 (e.g., the earbud device 512) including and a personal computing device 660 (e.g., the personal computing device 514, a smartphone, or a tablet) that communicates with the earbud device 640 via a wireless communications link 650. The earbud device 640 includes an eartip 642 with electrodes, one or more motion sensors 644, and a communications interface 646, which may communicate with each other via a bus 648. The personal computing device 660 includes a processing apparatus 662, a user interface 664, and a communications interface 666, which may communicate with each other via a bus 668. In some implementations (not shown in FIG. 6B), the system 630 includes a second earbud device (e.g., the second earbud device 522) for a second ear canal, which is similar to the first earbud device 640 and is also in communication with the personal computing device 660 via a wireless communications link. The system 630 may be used to implement processes described in this disclosure, such as the technique 700 of FIG. 7, the technique 800 of FIG. 8, the technique 900 of FIG. 9, the technique 1000 of FIG. 10, the technique 1100 of FIG. 11, the technique 1200 of FIG. 12, the technique 1600 of FIG. 16, the technique 1700 of FIG. 17, the technique 1800 of FIG. 18, the technique 1900 of FIG. 19, the technique 2000 of FIG. 20, the technique 2100 of FIG. 21, the technique 2200 of FIG. 22, the technique 2300 of FIG. 23, and/or the technique 2400 of FIG. 24.

The earbud device 640 includes an eartip 642 (e.g., the eartip 510 or the eartip 400) with electrodes. The system 630 includes a first electrode positioned on an outer surface of the eartip 642, a second electrode positioned on an outer surface of the eartip 642, and a third electrode positioned on an outer surface of the eartip 642. In some implementations, the system 630 includes additional electrodes on the eartip 642. For example, the system 630 may include a fourth electrode (e.g., the fourth electrode 416) positioned on an outer surface of the eartip 642. The eartip 642 may be removably attached to the earbud device 640 and the eartip 642 may be shaped for insertion in an ear canal. The eartip 642 may be configured to position the first electrode, the second electrode and the third electrode in contact with an inside surface (i.e., skin) of an ear canal.

The personal computing device 660 includes a processing apparatus 662. The processing apparatus 662 may include one or more processors having a single or multiple processing cores. The processing apparatus 662 may include memory, such as random access memory device (RAM), flash memory, or any other suitable type of storage device such as a non-transitory computer readable memory. The memory of the processing apparatus 662 may include executable instructions and data that can be accessed by one or more processors of the processing apparatus 662. For example, the processing apparatus 662 may include one or more DRAM modules such as double data rate synchronous dynamic random-access memory (DDR SDRAM). In some implementations, the processing apparatus 662 may include a digital signal processor (DSP). In some implementations, the processing apparatus 662 may include an application specific integrated circuit (ASIC). For example, the processing apparatus 662 may include a custom vector processor for efficiently executing machine learning models at an inference phase.

The processing apparatus 662 may be configured to access measurements of electrical potential of the first electrode, the second electrode, and the third electrode; determine a reference signal based on measurements of electrical potential of the first electrode; determine a ground signal (e.g., an active ground signal) based on measurements of electrical potential of the second electrode; determine a first electroencephalography signal based on measurements of electrical potential of the third electrode and based on the reference signal; and estimate a brain state based on the first electroencephalography signal. In some implementations, the eartip 642 includes a fourth electrode and the processing apparatus 662 is configured to access measurements of electrical potential of the fourth electrode; determine a second electroencephalography signal based on measurements of electrical potential of the fourth electrode and based on the reference signal; and estimate the brain state based on the second electroencephalography signal. The processing apparatus 662 may be configured to receive the measurements of electrical potential of the third electrode via the wireless communications link 650, using the communications interface 666.

Although not explicitly shown in FIG. 6B, the earbud device 640 may include measurement circuitry configured to measure voltages at the electrodes on the eartip 642 and make those measurements accessible (e.g., via the bus 648 and the communication interface 646) to the processing apparatus 662. For example, the earbud device 640 may include circuitry depicted in the signal flow 1300 of FIG. 13 for amplifying and sampling the voltages at the electrodes on the eartip 642.

The earbud device 640 includes one or more motion sensors 644, which may be configured to detect motion of an earbud device 640 with respect to an ear canal during use that can cause artifacts in an electroencephalography signal. For example, the one or more motion sensors 644 may include a contact sensor positioned near an anterior end of the eartip 642, an accelerometer, and/or a gyroscope. For example, the processing apparatus 662 may be configured to access measurements from a contact microphone, and identify artifacts in the first electroencephalography signal caused by motion of the eartip 642 within the ear canal based on the measurements from the contact microphone. For example, the processing apparatus may be configured to access measurements from an accelerometer, and identify artifacts in the first electroencephalography signal caused by motion of the eartip 642 within the ear canal based on the measurements from the accelerometer. For example, the processing apparatus may be configured to access measurements from a gyroscope, and identify artifacts in the first electroencephalography signal caused by motion of the eartip 642 within the ear canal based on the measurements from the gyroscope.

The earbud device 640 includes the communications interface 646 and the personal computing device 660 includes the communications interface 666, which may together enable communications between the two devices via the wireless communications link 650. For example, the communications interface 646 may be used to receive commands controlling operation of the and configuration of an in-ear brain-computer interface provided by the earbud device 640. For example, the wireless communications link 650 may be used to transfer data (e.g., including measurements of electrical potential of the first electrode, the second electrode, and the third electrode) from the earbud device 640 to the personal computing device 660. For example, the communications interface 646 and the communication interface 666 may include a wireless interface, such as a Bluetooth interface, a ZigBee interface, and/or a Wi-Fi interface.

The personal computing device 660 may include a user interface 664. For example, the user interface 664 may include a controller for a speaker in the earbud device 640, which may be used to play audio signals, including audio prompts for a user. For example, the user interface 664 may include one or more microphones, which may configured accept audio signals and detect verbal commands from a user. For example, the user interface 664 may include an LCD display for presenting images and/or messages to a user. For example, the user interface 664 may include a button or capacitive touch sensor for activating or deactivating the in-ear brain-computer interface.

FIG. 7 is flowchart of an example of a technique 700 for providing an in-ear brain-computer interface. The technique 700 includes accessing 702 measurements of electrical potential of a first electrode, a second electrode, and a third electrode that are in contact with an inside surface of an ear canal; determining 704 a reference signal based on measurements of electrical potential of the first electrode; determining 706 a ground signal based on measurements of electrical potential of the second electrode; determining 708 a first electroencephalography signal based on measurements of electrical potential of the third electrode and based on the reference signal; estimating 710 a brain state based on the first electroencephalography signal; and storing, displaying, or transmitting 712 an indication of the estimated brain state. For example, technique 700 may be implemented using the system 100 of FIGS. 1A-E. For example, technique 700 may be implemented using the system 200 of FIGS. 2A-E. For example, technique 700 may be implemented using the system 300 of FIGS. 3A-E. For example, technique 700 may be implemented using the system 500 of FIGS. 5A-C. For example, technique 700 may be implemented using the system 600 of FIG. 6A. For example, technique 700 may be implemented using the system 630 of FIG. 6B.

The technique 700 includes accessing 702 measurements of electrical potential of a first electrode, a second electrode, and a third electrode that are in contact with an inside surface of an ear canal. In some implementations, accessing 702 the measurements of electrical potential includes sampling (e.g., at 300 Hz) the electrical potential of a conductor connected to the third electrode. For example, the measurements of electrical potential may be accessed 702 using the signal flow 1300 of FIG. 13. In some implementations, accessing 702 the measurements of electrical potential includes receiving the measurements of electrical potential of the electrodes (e.g., including the third electrode 534) via a wireless communications link (e.g. the wireless communications link 650). For example, the measurements of electrical potential may be received using the communications interface 666 of the personal computing device 660.

The technique 700 includes determining 704 a reference signal based on measurements of electrical potential of the first electrode. For example, the reference signal may be a digital signal including a sequence of samples (e.g., sampled at 300 Hz) of voltage at the first electrode. In some implementations, the voltage at the first electrode may be amplified before it is sampled and converted to a digital signal that can be forwarded to one or more processors of a processing apparatus (e.g., the processing apparatus 612 or the processing apparatus 662) for analysis.

The technique 700 includes determining 706 a ground signal based on measurements of electrical potential of the second electrode. For example, the ground signal may be an active ground signal. For example, the ground signal may be a digital signal including a sequence of samples (e.g., sampled at 300 Hz) of voltage at the second electrode. In some implementations, the voltage at the second electrode may be amplified before it is sampled and converted to a digital signal that can be forwarded to one or more processors of a processing apparatus (e.g., the processing apparatus 612 or the processing apparatus 662) for analysis. The second electrode may be used to apply driven right leg (DRL) signal to the ear canal to suppress common mode noise that may be present at the electrodes. For example, the technique 800 of FIG. 8 may be implemented to suppress common mode noise at the electrodes.

The technique 700 includes determining 708 a first electroencephalography signal based on measurements of electrical potential of the third electrode and based on the reference signal. The first electroencephalography signal may include signals from a brain of a user. For example, the first electroencephalography signal may be a digital signal including a sequence of samples (e.g., sampled at 300 Hz) of voltage between the third electrode and the first electrode. In some implementations, the voltage at the third electrode may be amplified before it is sampled and converted to a digital signal that can be forwarded to one or more processors of a processing apparatus (e.g., the processing apparatus 612 or the processing apparatus 662) for analysis. For example, determining 708 a first electroencephalography signal may include subtracting samples of voltage at the third electrode from corresponding samples of voltage at the first electrode. In some implementations, additional channels of electroencephalography data may be acquired using additional electrodes to improve detection of electromagnetic signals from the brain. For example, the technique 900 of FIG. 9 may be implemented to utilize a fourth electrode in contact with the ear canal to determine a second electroencephalography signal. In some implementations, additional channels of electroencephalography data may be acquired using electrodes that are in contact with an inside surface of a second ear canal of the user (e.g., electrodes of the second eartip 520). In some implementations, determining 708 the first electroencephalography signal may include filtering to remove noise (e.g., 50 Hz or 60 Hz noise from power lines).

The technique 700 includes estimating 710 a brain state based on the first electroencephalography signal. For example, the brain state may include an amplitude or power of alpha waves (e.g., in a frequency range of 8 Hz to 12 Hz) present in an analysis window (e.g., a 1 second or 2 second analysis window). For example, the brain state may include an amplitude or power of beta waves (e.g., in a frequency range of 12 Hz to 30 Hz), gamma waves (e.g., in a frequency range of 30 Hz to 100 Hz), theta waves (e.g., in a frequency range of 4 Hz to 8 Hz), and/or delta waves (e.g., in a frequency range of 1 Hz to 4 Hz) present in an analysis window. For example, estimating 710 the brain state may include performing a power spectral density analysis (e.g., using a Fast Fourier Transform (FFT)) of the first electroencephalography signal in a window of time. In some implementations, the estimate of brain state includes a prediction generated with a machine learning model based on a window of samples from the first electroencephalography signal and/or features derived from the first electroencephalography signal. The prediction is an inference phase output of the machine learning model (e.g., including a neural network with one or more hidden layers), which, as a result of training of the model, may be correlated with a brain activity or status of the brain. For example, the estimate of brain state may include a prediction correlated with a level of focus, a level of attentiveness, a level of cognitive load, fatigue, or sleepiness. In some implementations, the estimated brain state includes a vector of predictions and/or features determined based on the first electroencephalography signal and/or additional electroencephalography signals captured from a user.

The technique 700 includes storing, displaying, or transmitting 712 an indication of the estimated brain state. For example, the indication of the estimated brain state may be transmitted 712 to an external device (e.g., a smartphone, laptop, or tablet) for display or storage. For example, the indication of the estimated brain state may be transmitted 712 via the communications interface 618. For example, the indication of the estimated brain state may be displayed 712 in the user interface 620 or in the user interface 664. For example, the indication of the estimated brain state may be stored 712 in memory of the processing apparatus 612 or in memory of the processing apparatus 662.

FIG. 8 is flowchart of an example of a technique 800 for suppressing common mode noise in one or more electroencephalography channels of an in-ear brain-computer interface. The technique 800 includes driving 802 a driven right leg (DRL) voltage to the second electrode to suppress common mode noise in the first electroencephalography signal. For example, the DRL voltage may be generated using circuitry including an inverting amplifier configured to detect the common voltage between the first electrode and the third electrode, invert the common voltage, and the add it back to the ear canal via the second electrode to suppress common mode noise in the measurements used to determine one or more electroencephalography signals. For example, technique 800 may be implemented using the system 100 of FIGS. 1A-E. For example, technique 800 may be implemented using the system 200 of FIGS. 2A-E. For example, technique 800 may be implemented using the system 300 of FIGS. 3A-E. For example, technique 800 may be implemented using the system 500 of FIGS. 5A-C. For example, technique 800 may be implemented using the system 600 of FIG. 6A. For example, technique 800 may be implemented using the system 630 of FIG. 6B.

FIG. 9 is flowchart of an example of a technique 900 for adding an additional electroencephalography channel in an in-ear brain-computer interface. The technique 900 includes accessing 902 measurements of electrical potential of a fourth electrode that is in contact with the inside surface of the ear canal; determining 904 a second electroencephalography signal based on measurements of electrical potential of the fourth electrode and based on the reference signal; and estimating 906 the brain state based on the second electroencephalography signal. For example, technique 900 may be implemented using the system 100 of FIGS. 1A-E. For example, technique 900 may be implemented using the system 200 of FIGS. 2A-E. For example, technique 900 may be implemented using the system 300 of FIGS. 3A-E. For example, technique 900 may be implemented using the system 500 of FIGS. 5A-C. For example, technique 900 may be implemented using the system 600 of FIG. 6A. For example, technique 900 may be implemented using the system 630 of FIG. 6B.

The technique 900 includes accessing 902 measurements of electrical potential of a fourth electrode that is in contact with the inside surface of the ear canal. In some implementations, accessing 902 the measurements of electrical potential of the fourth electrode includes sampling (e.g., at 300 Hz) the electrical potential of a conductor connected to the fourth electrode. For example, the measurements of electrical potential may be accessed 902 using the signal flow 1300 of FIG. 13. In some implementations, accessing 902 the measurements of electrical potential includes receiving the measurements of electrical potential of the fourth electrode via a wireless communications link (e.g. the wireless communications link 650). For example, the measurements of electrical potential of the fourth electrode may be received using the communications interface 666 of the personal computing device 660.

The technique 900 includes determining 904 a second electroencephalography signal based on measurements of electrical potential of the fourth electrode and based on the reference signal. The second electroencephalography signal may include signals from a brain of a user. The second electroencephalography signal may provide an additional channel of data regarding brain signals when combined with the first electroencephalography signal and/or other electroencephalography signals. For example, the second electroencephalography signal may be a digital signal including a sequence of samples (e.g., sampled at 300 Hz) of voltage between the fourth electrode and the first electrode. In some implementations, the voltage at the fourth electrode may be amplified before it is sampled and converted to a digital signal that can be forwarded to one or more processors of a processing apparatus (e.g., the processing apparatus 612 or the processing apparatus 662) for analysis. For example, determining 904 the second electroencephalography signal may include subtracting samples of voltage at the fourth electrode from corresponding samples of voltage at the first electrode. In some implementations, determining 904 the second electroencephalography signal may include filtering to remove noise (e.g., 50 Hz or 60 Hz noise from power lines).

The technique 900 includes estimating 906 the brain state based on the second electroencephalography signal. For example, estimating 906 the brain state may include analyzing the second electroencephalography signal the in the same ways described above for analyzing the first electroencephalography signal to estimate 710 the brain state. In some implementations, additional analysis may be performed to compare the first electroencephalography signal and the second electroencephalography signal. For example, coherence features may be determined that represent how respective signals from different electrodes correspond to each other. Coherence features may be based on comparisons of powerband data from respective pairs of electrodes (e.g., the third electrode 414 and the fourth electrode 416). The comparisons may determine a degree of similarity between the corresponding electrodes with respect to each compared power band (e.g. alpha, beta, theta, delta, and/or gamma). In some embodiments higher levels of coherence may between corresponding electrodes may indicate a higher signal to noise ratio. The coherence features may be input, along with other features based on the first electroencephalography signal and the second electroencephalography signal to one or more machine learning models that are used to generate one or more predictions as components of the estimated brain state. For example, the estimated brain state may include predictions that are correlated with a level of focus, a level of attentiveness, a level of cognitive load, fatigue, and/or sleepiness.

FIG. 10 is flowchart of an example of a technique 1000 for identifying artifacts in an electroencephalography signal caused by motion of an eartip using a contact microphone. The technique 1000 includes accessing 1002 measurements from a contact microphone; and identifying 1004 artifacts in the first electroencephalography signal caused by motion of the third electrode within the ear canal based on the measurements from the contact microphone. For example, technique 1000 may be implemented using the system 100 of FIGS. 1A-E. For example, technique 1000 may be implemented using the system 200 of FIGS. 2A-E. For example, technique 1000 may be implemented using the system 300 of FIGS. 3A-E. For example, technique 1000 may be implemented using the system 500 of FIGS. 5A-C. For example, technique 1000 may be implemented using the system 600 of FIG. 6A. For example, technique 1000 may be implemented using the system 630 of FIG. 6B.

The technique 1000 includes accessing 1002 measurements from a contact microphone. The contact microphone may be part of an earbud device (e.g., the earbud device 112, the earbud device 212, the earbud device 312, the earbud device 512 or the earbud device 640). For example, the contact microphone may be positioned near an anterior end of an eartip on the earbud device. For example, the measurements may be accessed 1002 by reading the measurements from the contact microphone via a bus (e.g., the bus 624). In some implementations, accessing 1002 measurements may include receiving the measurements via a communications link (e.g., the wireless communications link 650). For example, the measurements may be accessed 1002 via a wireless or wired communications interface (e.g., Wi-Fi, Bluetooth, USB, HDMI, Wireless USB, Near Field Communication (NFC), Ethernet, a radio frequency transceiver, and/or other interfaces). For example, the measurements may be accessed 1002 using communications interface 666.

The technique 1000 includes identifying 1004 artifacts in the first electroencephalography signal caused by motion of the third electrode within the ear canal based on the measurements from the contact microphone. The contact microphone may record loud sounds when an eartip on which the electrodes are positioned in is moved within the canal. This type of motion may cause transient changes in impedance between the electrodes and the skin of the ear canal. The measurements from the contact microphone may be analyzed to detect such a motion related event and to predict how an artifact of this event would manifest in the first electroencephalography signal. For example, identifying 1004 artifacts in the first electroencephalography signal may include passing a sequence of measurements from the contact microphone through a high-pass filter and comparing the output of the filter to threshold. Identifying 1004 such an artifact in the first electroencephalography signal may enable the artifact to be subtracted or otherwise filtered out of the first electroencephalography signal to improve a signal to noise ratio (SNR) of the first electroencephalography signal. In some implementations, identifying 1004 artifacts in the first electroencephalography signal based on the measurements from the contact microphone may include inputting measurement data from the contact sensor and/or features extracted from this measurement data in a analysis window, along with data derived from the first electroencephalography signal, to one or more machine learning models that are trained to generate predictions of an estimated brain state in the presence of such artifacts.

FIG. 11 is flowchart of an example of a technique 1100 for identifying artifacts in an electroencephalography signal caused by motion of an eartip using an accelerometer. The technique 1100 includes accessing 1102 measurements from an accelerometer; and identifying 1104 artifacts in the first electroencephalography signal caused by motion of the third electrode within the ear canal based on the measurements from the accelerometer. For example, technique 1100 may be implemented using the system 100 of FIGS. 1A-E. For example, technique 1100 may be implemented using the system 200 of FIGS. 2A-E. For example, technique 1100 may be implemented using the system 300 of FIGS. 3A-E. For example, technique 1100 may be implemented using the system 500 of FIGS. 5A-C. For example, technique 1100 may be implemented using the system 600 of FIG. 6A. For example, technique 1100 may be implemented using the system 630 of FIG. 6B.

The technique 1100 includes accessing 1102 measurements from an accelerometer. The accelerometer may be part of an earbud device (e.g., the earbud device 112, the earbud device 212, the earbud device 312, the earbud device 512 or the earbud device 640). For example, the measurements may be accessed 1102 by reading the measurements from the accelerometer via a bus (e.g., the bus 624). In some implementations, accessing 1102 measurements may include receiving the measurements via a communications link (e.g., the wireless communications link 650). For example, the measurements may be accessed 1102 via a wireless or wired communications interface (e.g., Wi-Fi, Bluetooth, USB, HDMI, Wireless USB, Near Field Communication (NFC), Ethernet, a radio frequency transceiver, and/or other interfaces). For example, the measurements may be accessed 1102 using communications interface 666.

The technique 1100 includes identifying 1104 artifacts in the first electroencephalography signal caused by motion of the third electrode within the ear canal based on the measurements from the accelerometer. The accelerometer measurements may reflect when an eartip on which the electrodes are positioned in is moved within the canal. This type of motion may cause transient changes in impedance between the electrodes and the skin of the ear canal. The measurements from the accelerometer may be analyzed to detect such a motion related event and to predict how an artifact of this event would manifest in the first electroencephalography signal. For example, identifying 1104 artifacts in the first electroencephalography signal may include passing a sequence of measurements from the accelerometer through a high-pass filter and comparing the output of the filter to threshold. Identifying 1104 such an artifact in the first electroencephalography signal may enable the artifact to be subtracted or otherwise filtered out of the first electroencephalography signal to improve a signal to noise ratio (SNR) of the first electroencephalography signal. In some implementations, identifying 1104 artifacts in the first electroencephalography signal based on the measurements from the accelerometer may include inputting measurement data from the accelerometer and/or features extracted from this measurement data in a analysis window, along with data derived from the first electroencephalography signal, to one or more machine learning models that are trained to generate predictions of an estimated brain state in the presence of such artifacts.

FIG. 12 is flowchart of an example of a technique 1200 for identifying artifacts in an electroencephalography signal caused by motion of an eartip using a gyroscope. The technique 1200 includes accessing 1202 measurements from a gyroscope; and identifying 1204 artifacts in the first electroencephalography signal caused by motion of the third electrode within the ear canal based on the measurements from the gyroscope. For example, technique 1200 may be implemented using the system 100 of FIGS. 1A-E. For example, technique 1200 may be implemented using the system 200 of FIGS. 2A-E. For example, technique 1200 may be implemented using the system 300 of FIGS. 3A-E. For example, technique 1200 may be implemented using the system 500 of FIGS. 5A-C. For example, technique 1200 may be implemented using the system 600 of FIG. 6A. For example, technique 1200 may be implemented using the system 630 of FIG. 6B.

The technique 1200 includes accessing 1202 measurements from a gyroscope. The gyroscope may be part of an earbud device (e.g., the earbud device 112, the earbud device 212, the earbud device 312, the earbud device 512 or the earbud device 640). For example, the measurements may be accessed 1202 by reading the measurements from the gyroscope via a bus (e.g., the bus 624). In some implementations, accessing 1202 measurements may include receiving the measurements via a communications link (e.g., the wireless communications link 650). For example, the measurements may be accessed 1202 via a wireless or wired communications interface (e.g., Wi-Fi, Bluetooth, USB, HDMI, Wireless USB, Near Field Communication (NFC), Ethernet, a radio frequency transceiver, and/or other interfaces). For example, the measurements may be accessed 1202 using communications interface 666.

The technique 1200 includes identifying 1204 artifacts in the first electroencephalography signal caused by motion of the third electrode within the ear canal based on the measurements from the gyroscope. The gyroscope measurements may reflect when an eartip on which the electrodes are positioned in is moved within the canal. This type of motion may cause transient changes in impedance between the electrodes and the skin of the ear canal. The measurements from the gyroscope may be analyzed to detect such a motion related event and to predict how an artifact of this event would manifest in the first electroencephalography signal. For example, identifying 1204 artifacts in the first electroencephalography signal may include passing a sequence of measurements from the gyroscope through a high-pass filter and comparing the output of the filter to threshold. Identifying 1204 such an artifact in the first electroencephalography signal may enable the artifact to be subtracted or otherwise filtered out of the first electroencephalography signal to improve a signal to noise ratio (SNR) of the first electroencephalography signal. In some implementations, identifying 1204 artifacts in the first electroencephalography signal based on the measurements from the gyroscope may include inputting measurement data from the gyroscope and/or features extracted from this measurement data in a analysis window, along with data derived from the first electroencephalography signal, to one or more machine learning models that are trained to generate predictions of an estimated brain state in the presence of such artifacts.

FIG. 13 is a signal flow diagram of an example of a signal flow 1300 in an in-ear brain-computer interface. The measurements of electrical potential are collected at a set of electrodes, including a first electrode 1302, a second electrode 1304, a third electrode 1306, and an Nth electrode 1308. The first electrode 1302, the second electrode 1304, and the third electrode are positioned in an ear canal, in contact with skin of the ear canal. In some implementations, all of the electrodes are positioned inside of the ear canal. In some implementations, one or more additional electrodes (e.g., the Nth electrode 1308) are located inside a second ear canal of the user. In some implementations, one or more additional electrodes (e.g., the Nth electrode 1308) are located elsewhere on the user’s body, in contact with the user’s skin outside of the ear canals. These electrodes may be used to collect one or more channels of electroencephalography data that may include electromagnetic signals from a brain of the user. The first electrode 1302 may be used as a common reference electrode. The second electrode 1304 may be used as a ground/driven right leg (DRL) electrode. The third electrode 1306 may be used as a first electroencephalography channel electrode, and the Nth electrode 1308 may be used as an additional electroencephalography channel electrode.

The voltages at the electrodes are amplified using respective operational amplifiers 1312, 1314, 1316, and 1318. The amplified voltages output from the operational amplifiers 1312, 1314, 1316, and 1318 are input to respective analog-to-digital converters 1322, 1324, 1326, and 1328 to obtain digital signals including sequences of measurements from the electrodes 1302, 1304, 1306, and 1308.

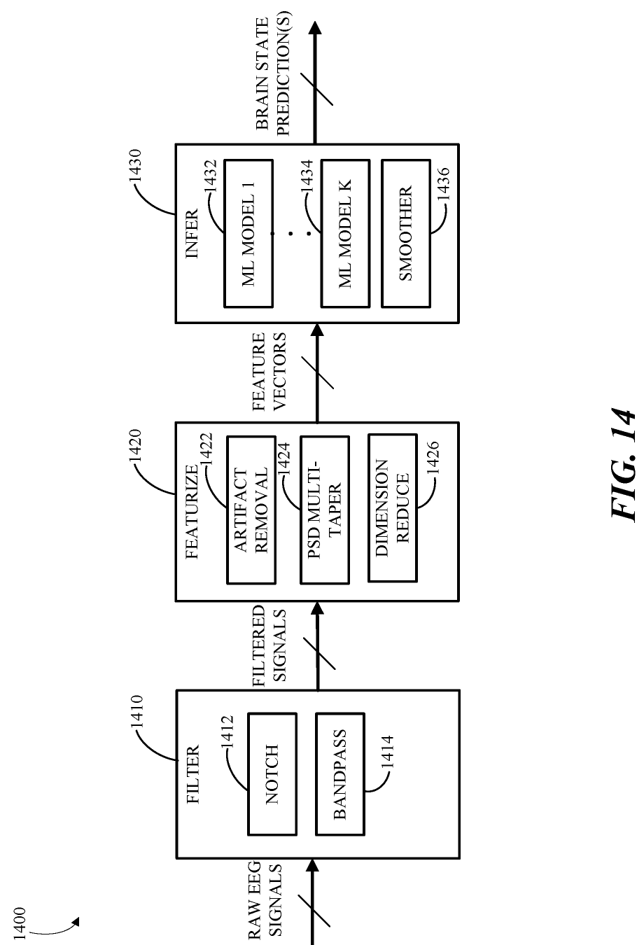

These digital signals from the analog-to-digital converters 1322, 1324, 1326, and 1328 are then input to an electroencephalography signal processing pipeline 1330, which is configured to analyze the digital signals from the electrodes and determine an estimate of brain state based, at least in part, on these digital signals. For example, the electroencephalography signal processing pipeline 1330 may determine a first channel of electroencephalography data by subtracting voltage measurements of the first electrode 1302 from voltage measurements of the third electrode 1306 to obtain a first electroencephalography signal. The electroencephalography signal processing pipeline 1330 may be configured to estimate a brain state based on one or more of these electroencephalography signals. For example, the electroencephalography signal processing pipeline 1330 may be configured to perform power spectral density analysis of a set of one or more electroencephalography signals derived from the measurement data from the electrodes 1302, 1304, 1306, 1308. In some implementations, the electroencephalography signal processing pipeline 1330 includes one or more machine learning models that have been trained to map electroencephalography signal(s) in a window of time (e.g., a 1 second or a 2 second window) and/or features derived from the electroencephalography signal(s) to one or more predictions that are correlated with aspects of a brain state (e.g., a level of focus, a level of attentiveness, a level of cognitive load, fatigue, or sleepiness). For example, the electroencephalography signal processing pipeline 1330 may periodically output a vector of brain state parameters, including features derived from the electroencephalography signal(s) (e.g., alpha wave power, beta wave power, gamma wave power, delta wave power, and/or theta wave power) and/or predictions from machine learning models. For example, the electroencephalography signal processing pipeline 1330 may include the electroencephalography signal processing pipeline 1400 of FIG. 14.

A driven-right-leg (DRL) circuitry 1340 may also be connected to the second electrode 1304 and configured to drive a DRL voltage signal to the skin in the ear canal via the second electrode 1304 to suppress common mode noise in the voltage signals from the other electrodes. For example, the DRL circuitry 1340 may include an inverting amplifier configured to detect the common voltage between the first electrode 1302 and the third electrode 1306, invert the common voltage, and the add it back to the ear canal via the second electrode 1304 to suppress common mode noise in the measurements used to determine the one or more electroencephalography signals.

FIG. 14 is a signal flow diagram of an example of an electroencephalography signal processing pipeline 1400 in an in-ear brain-computer interface. The electroencephalography signal processing pipeline 1400 includes a filter stage 1410, a featurize stage 1420, and an infer stage 1430. The electroencephalography signal processing pipeline 1400 receives one or more raw electroencephalography signals and inputs them to the filter stage 1410. The filter stage 1410 includes a notch filter 1412 and a bandpass filter 1414 that may be used to suppress noise (e.g., 50 Hz or 60 Hz noise from power lines) in the raw electroencephalography signals to generate filtered signals with higher signal-to-noise ratio (SNR).

The filtered signals are output from the filter stage 1410 and input to the featurize stage 1420. The featurize stage 1420 includes an artifact removal module 1422, a power spectral density multi-taper module 1424, and a dimension reduce module 1426. The artifact removal module 1422 may be configured to identify artifacts in the filtered signals based on out-of-band data (not shown explicitly in FIG. 14) that is synchronized with the filtered signals. For example, this out-of-band data may include measurements from a contact microphone, an accelerometer, and/or a gyroscope positioned near the one or more of the electrodes (e.g., in the earbud device 512). This out-of-band data may reflect motion of one or more of the electrodes (e.g., including the third electrode 1306) within the ear canal, which may cause transient changes in impedance between the electrodes and the skin the ear canal, resulting in artifacts in the filter signals that may be predicted and removed by the artifact removal module 1422.

The featurize stage 1420 includes a power spectral density multi-taper module 1424 that is configured to perform a power spectral density analysis (e.g., using a Fast Fourier Transform (FFT)) of the filtered signals to determine a set of features of the signals. For example, the set of features determined by the power spectral density multi-taper module 1424 may include power in the alpha (8-12 Hz), beta (12-30 Hz), theta (4-8 Hz), gamma (30-100 Hz), and/or Delta (1-4 Hz) frequency ranges for each of the one or more filtered electroencephalography signals.

The featurize stage 1420 includes a dimension reduce module 1426 that is configured to perform a dimension reduction operation (e.g., a linear mapping based on a principle components analysis) to map a set of features from the power spectral density multi-taper module 1424 and/or additional features extracted from the filtered signals to a smaller vector of features that has higher entropy per element. The resulting vector of features may be output from the featurize stage 1420.

The vector of features output from the featurize stage 1420 is input to the infer stage 1430. The infer stage 1430 includes one or more machine learning models, including a first machine learning model 1432 and a Kth machine learning model 1434 that are trained to generate predictions based on a vector of features from the featurize stage 1420. As a result of the training of these models, the predictions may be correlated with aspects of a brain state, such as, for example, a level of focus, a level of attentiveness, a level of cognitive load, fatigue, and/or sleepiness. The infer stage 1430 includes a smoother module 1436 that is configured to apply low-pass filtering to a sequence of predictions from on the machine learning models (e.g., the first machine learning model 1432). The set of predictions, with or without smoothing, may then be output from the infer stage 1430 as vector of brain state predictions. The vector of brain state predictions may serve as an estimate of a brain state. In some implementations, an estimate of the brain state output from the electroencephalography signal processing pipeline 1400 includes both the vector of brain state predictions and a corresponding vector of features from the featurize stage 1420.

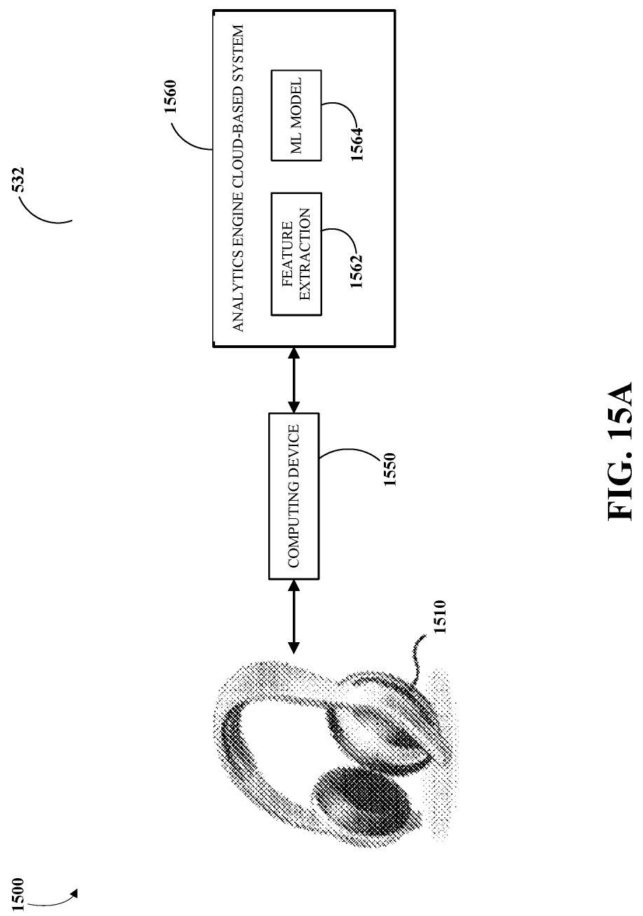

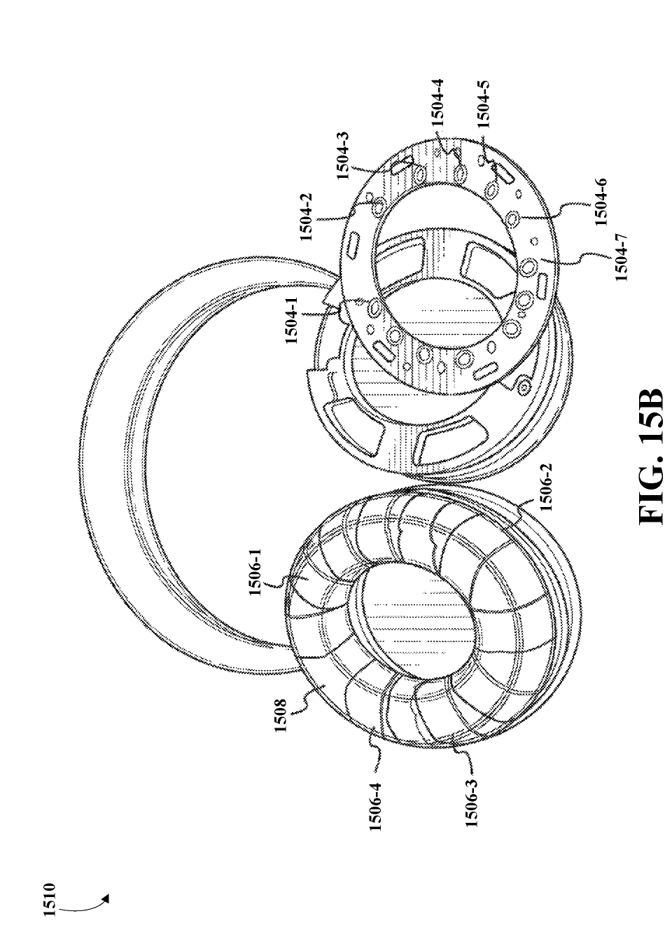

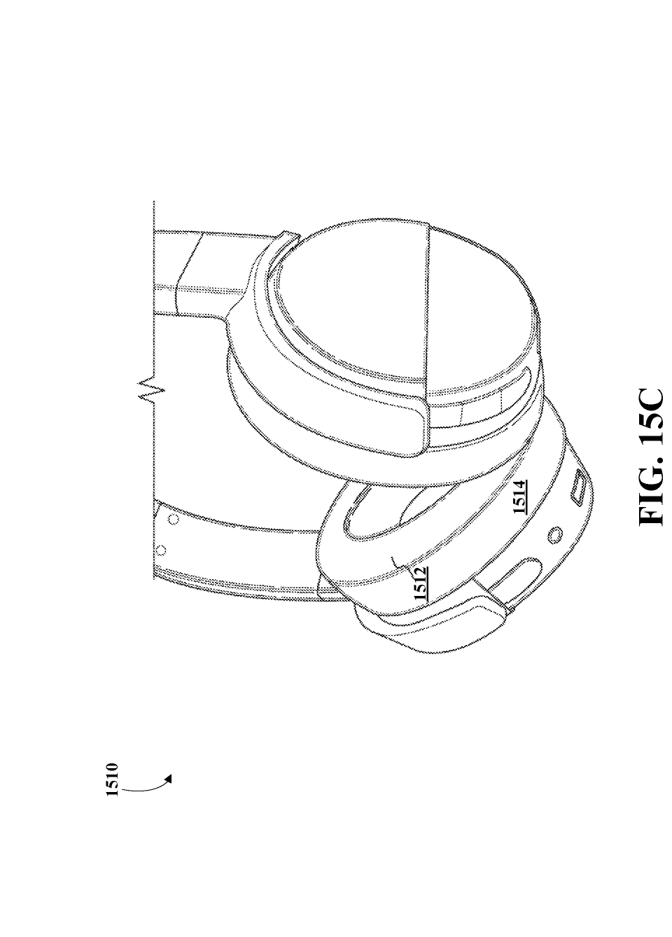

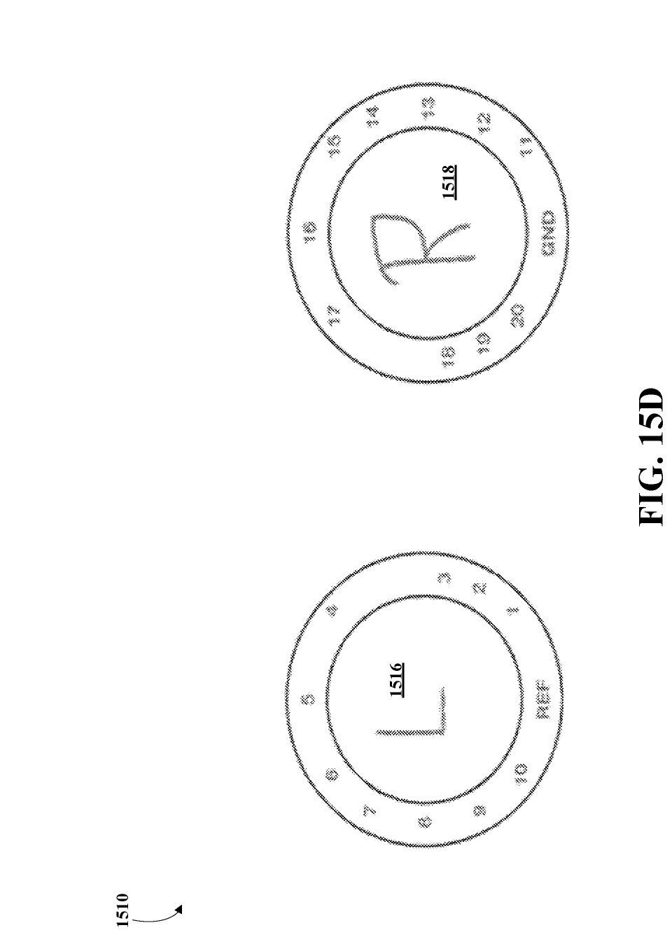

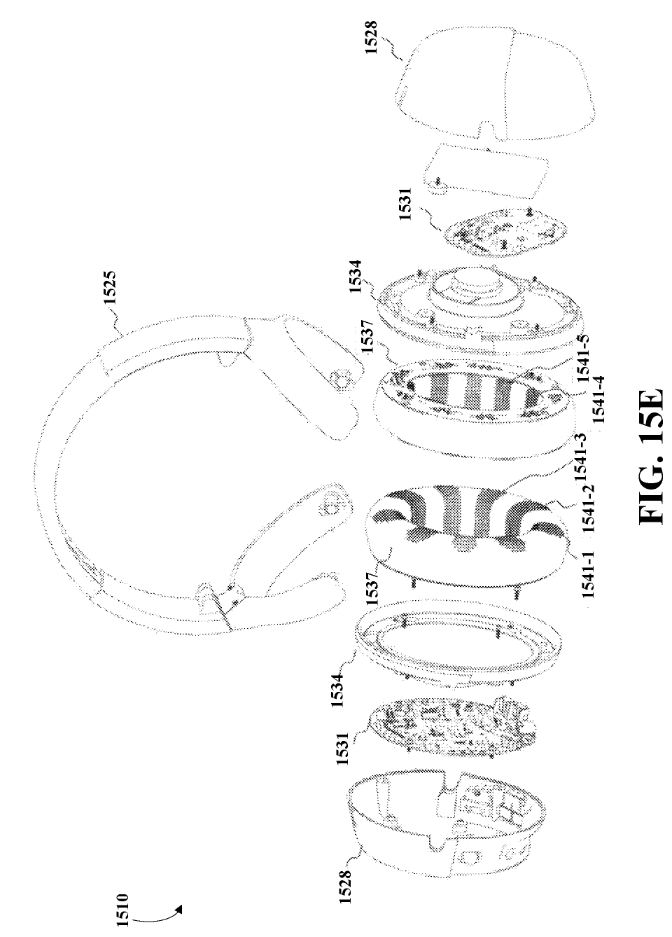

FIG. 15A is a block diagram of an example of a system 1500 including a hearable interface. The system includes headphones 1510 configured to position a left speaker near a left ear and a right speaker near a right ear when worn by a human. The left speaker and/or the right speaker may be used to present audio output to a human user wearing the headphones, which may include multiple sounds corresponding to respective menu options of a hearable interface. The headphones 1510 may also include various sensors that may be used to detect control input signals from a human user wearing the headphones, such as, for example, an inertial measurement unit (e.g., including an accelerometer and/or a gyroscope), which may be used to detect motions of the headphones 1510, and/or a set of electrodes attached to the headphones 1510, which may be used to detect electromyography signals and/or electroencephalography signals. The headphones may be configured to position the set of electrodes on a head of the human (e.g., positioned around the ears and/or in the ear canals of the human. In some implementations, these control input signals from a human user wearing the headphones may be used to select respective menu options of a hearable interface. The system 1500 may be used to implement processes described in this disclosure, such as the technique 1600 of FIG. 16, the technique 1700 of FIG. 17, the technique 1800 of FIG. 18, the technique 1900 of FIG. 19, the technique 2000 of FIG. 20, the technique 2100 of FIG. 21, the technique 2200 of FIG. 22, the technique 2300 of FIG. 23, and/or the technique 2400 of FIG. 24.

The system 1500 includes a set of headphones 1510 whereby a user wearing the headphones 1510 can interact with (or control) a computer device(s) 1550 based on data from electrodes and/or one or more motion sensors (e.g., an inertial measurement unit) on the headphones 1510. The electrodes may continually monitor and detect voltages and the signals may be sampled, digitized (e.g. using an a/d converter), and converted to a floating-point representation of time series data that are buffered on the headphones 1510. The time series data may be aggregated, then packaged into a network compatible format for sending to an associated device (e.g. sending via Bluetooth to a connected smartphone). In various embodiments the data may be further sent from the associated device 1550 (e.g. a smartphone, or a smart earbud charging case with a SIM card for passing cellular network messages to and from the headphones 1510) to the cloud, for instance using Kafka over a secure socket connection (SSL) for storage and/or analysis. The user may perform one or more facial gestures that may be detected by the one or more electrodes integrated into the headphones 1510. A facial gesture may be, for example, a jaw movement, a jaw clench, a jaw wiggle left and right, a jaw jutting (e.g. jutting jaw forward and backward), a jaw opening, a tooth click, a smile, a cheek puff, a cheek suck, a blink, a wink, a tongue movement, a nose movement, an inhalation or exhalation, an eye movement, a frown, an eyebrow raise, an eyebrow lowering, a mouth movement, a whispered word or phrase, a silent vocalization, and any type of facial muscle movement, head movement, and any type of jaw movement, asymmetric variations of the former, and combinations thereof. For instance, a facial gesture may include a double jaw clench (consisting of two consecutive jaw clenches in a short time window), or a left-right-left-right jaw wiggle (consisting of a jaw moving first left, then right, then left, then right in a short time window). For instance, the user may wink with just the left eye or just the right eye, or the user may puff out just the left cheek or just the right cheek. The facial gesture may also include certain types of gestures that are very subtle, for instance the action of silently vocalizing a word. In certain scenarios a user may not want their facial gestures to be noticed by others, or may not want certain commands to be heard by others. In this case one can silently move their mouth as if they were stating a specific word, but not actually saying it out loud. By moving their mouth as if they were saying the word, the muscles in the mouth, tongue, neck, face, and lips move, and the movement of those muscles can be detected by the sensors on the headphones 1510. In various embodiments, this type of silent vocalization (SiVox) can be detected by the one or more electrodes integrated into the headphones 1510. one

Data from the electrodes may represent the detected facial gestures that correspond to a defined interaction. In various embodiments, the voltages may be generated by neurons in the user, and/or as a result of muscle movements and/or from brain waves and/or from other neural signals. A defined interaction may be mapped to a type of action. The system may implement the mapped action based on appropriate electrode data. In various embodiments a user interface may present the user with options to map/establish certain actions that are associated with specific facial gestures. For instance, a user may be presented with a list of facial gesture interactions and the user may then select certain actions to be associated with each interaction, like a double-jaw-clench 4 may be mapped to a mouse click, a head-nod-with-a-blink 4 may be mapped to a play/pause function in an audio/video application, a double-eyebrow-raise 4 may be mapped to opening a new file or application. A user may be presented the option to create new combinations of gestures and map them to different actions or combinations of actions. In various embodiments, a user interface may present the user with options to set certain thresholds for certain levels of mental states, along with actions to perform if the threshold is met or exceeded. For example, the analytics engine may determine if a user's level of focus has exceeded a certain threshold set by the user in the user interface, and if the user's level of focus has exceeded that threshold, then the Application Engine my send instructions to the User Device to disable notifications (e.g. enter a Do Not Disturb mode) that may be distracting to the User, thereby assisting the user to maintain a high level of focus.

In various embodiments, the headphones 1510 have a visual indicator (e.g. a light) that corresponds to different mental states (e.g. different colors), to levels of mental state (e.g. brightness light), and/or to certain thresholds of levels of mental states (e.g. on/off). For example, the visual indicator could serve as a type of ‘mood ring’, that changes color based on the mental state of the user. For example, the visual indicator could serve as a visual notice of the user being above a certain threshold of focus, so that a visual indicator on the headphones 1510 turns red to indicate that the user should not be disturbed, or if the user is below a certain threshold of focus the light turns green. In various embodiments, if a user is above a certain threshold of a mental state, and/or above a certain level of a mental state for a certain level of time, there is also a haptic feedback indicator (e.g. a vibrate sensation), that alerts the user of a notification. In various embodiments, the visual indicator is used as a driver of social interaction. For instance, if a user is above a certain threshold of mental fatigue, or has been above a certain level of mental fatigue for a certain level of time, then a haptic notification may be sent to the user (e.g. the headphones 1510 vibrate according to a certain pattern), a notification may be sent to the user's computing device to indicate that the user should take a break (e.g. a notification on the user's smartphone prompting the user to take a break), and/or a visual indicator on the headphones 1510 might light-up or change color (e.g. from do-not-disturb red when the user was focused, to needs-a-break blue when the user is mentally fatigued), which indicates to others around the user that the user is mentally fatigued and needs to take a break so the others know they can, and perhaps should interrupt the user to go on a walk together In various embodiments, if a user is above a certain threshold of a mental state, and/or above a certain level of a mental state for a certain level of time, there is also a haptic feedback indicator (e.g. a vibrate sensation), that alerts the user of a notification.

In various embodiments, the headphones 1510 also contain one or more motion sensors, such as an accelerometer and/or a gyroscope, which provide movement data to the computing device. The movement data can be combined with the EMG data to determine certain types of head movements, or head movements combined with facial gestures. Head movements may include head tilts, head nods, head shakes, head rotations, or the like, and may be combined with the facial gestures discussed above sequentially or coincidentally to indicate a certain desired interaction. A defined combination or sequence of interactions may be mapped to a type of action.

The headphones 1510 perform pre-processing and data is sent to the computer device(s) 1550 and/or then to a cloud computing platform 1560 for feature extraction 1562 and feeding extracted features into a machine learning model 1564. Output from the machine learning model 1564 may be sent to the computing device 1550 and may represent one or more types of actions to be performed or executed. Output from the machine learning model 1564 may be sent to the headphones 1510 via the computer device(s) 1550 and/or a cloud computing platform 1560. Output may represent one or more types of actions to be performed.

According to various embodiments, the buffered data on the headphones 1510 is converted into network packets, which are transmitted from the headphones 1510 to the computing device(s) 1550. In some embodiments the computing device 1550 has a self-contained analytics engine platform. For example, the computing device(s) 1550 may be a smart phone, a laptop, or a tablet. In some implementations, the computing device(s) 1550 is a smart earbud charging case with a SIM card for passing cellular network messages to and from the headphones 1510 via a Bluetooth link. For example, this smart charging case may include one or more processors configured to run applications controlled via the hearable interface that may be enabled using the technique 1600 of FIG. 16 and/or the technique 1700 of FIG. 17. The computing device 1550 may relay the one or more portions of the buffered data to the cloud computing platform 1560. The cloud computing platform 1560 may perform preprocessing, and signal processing, and analysis, and machine learning techniques to generate output. The output may be sent back from the cloud computing platform 1560 to the computing device(s) 1550. The computing device(s) 1550 may perform one or more actions based on the received output. In various embodiments, the computing device 1550 that sends the buffered data to the cloud computing platform 1560 may be different than a device that performs the one or more actions based on the received output sent back from the cloud computing platform 1560. In some embodiments the headphones 1510 have a self-contained computing device built into the hardware of the headphones. In some embodiments different parts and/or all of the preprocessing, signal processing, analysis, and machine learning processes can be executed on one or more computing devices and/or cloud computing platforms.

According to various embodiments, the headphones 1510 may be at least one of: circum-aural headphones, supra-aural headphones, headband headphones, over the ear headphones (e.g., as illustrated in FIGS. 2B-E), earbud headphones (e.g., the system 200), earpiece headphones (e.g., the system 300), and bone conduction headphones.

FIGS. 15B-E are illustrations of an example of an over-ear headphones 1510 that may be used to provide a hearable interface. According to various embodiments, as shown in FIG. 15B, the headphones 1510 may be (or include) a neural recording device configured to capture, record and/or transmit neural control signals from one or more brain regions indicating activity in the brain regions. The neural recording device can include any suitable recording device or system configured to record neural activity between the neurons, using any suitable approach. The neural recording device includes one or more electrodes 1504-1, 1504-2, 1504-3, 1504-4, 1504-5, 1504-6, 1504-7 that are configured to capture and record the neural signals from the one or more brain regions or one or more muscles. It is understood that a subset of the electrodes 1504-1, 1504-2, 1504-3, 1504-4, 1504-5, 1504-6, 1504-7 illustrated in FIG. 15B are accompanied by a corresponding reference numeral. It is further understood that one or more features illustrated in FIG. 15B that are similar in appearance to electrodes 1504-1, 1504-2, 1504-3, 1504-4, 1504-5, 1504-6, 1504-7 may also be interpreted as representing one or more additional electrodes. In some embodiments, the neural recording device can be configured to record and neural signals including signals that represent a user's voluntary muscle movements (e.g., eye-movements, postural movements, gestures) that can be used to implement a pointing control feature. In some embodiments the headphones may be configured to record involuntary muscle movements as well. In some embodiments, the signals acquired by the neural recording device can include neural signals corresponding to brain states such as cognitive, emotional, or attentive states of the user. In some embodiments, neural recording device can be configured to capture neural signals directly by electrically recording the primary ionic currents generated by neurons, the ionic currents flowing within and across neuronal assemblies. In some embodiments, neural recording device can be configured to capture neural signals indirectly by recording secondary currents or other changes in the nervous system, associated with or resulting from the primary currents. In some embodiments, the neural recording device can be specifically adapted to record one or more signals including a variety of signature brain signals such as Event Related Potentials (ERPs), Evoked Potentials (“Eps”, e.g., sensory evoked potentials such as visually evoked potentials (VEP), auditory evoked potentials (AEP), motor evoked potentials), motor imagery, brain state dependent signals, slow cortical potentials, and other, as yet undiscovered, signature activity potentials underlying various cognitive, attentive or sensorimotor tasks. In some embodiments, the neural recording device can be specifically adapted to record one or more signals in the frequency domain. Some examples among others include sensorimotor rhythms, Event Related Spectral Perturbations (ERSPs), specific signal frequency bands like Theta, Gamma or Mu rhythms, etc. As described herein, the neural recording device can record neural activity signals to gather information related to cognitive processes of a subject (such as a user) through a recording stage that measures brain activity and transduces the information into tractable electrical signals that can be converted into data that can be analyzed by a processor(s). As described above, the neural recording device can include a set of electrodes 1504-1 . . . 1504-7 . . . that acquire electroencephalography signals from different brain areas. These electrodes can measure electrical signals caused by the flow of electric currents during synaptic excitations of the dendrites in the neurons thereby relaying the effects of secondary currents. The neural signals can be recorded through the electrodes in the neural recording device appropriately arranged around the ear and jaw of a user. As described above, the neural recording device can include a set of electrodes 1504-1 . . . 1504-7 . . . that acquire electromyography signals from different muscles, and that acquire electrocardiography signals from the heart.

One or more embodiments may include a set of headphones 1510 with electrodes integrated with a conductive fabric 1506-1, 1506-2, 1506-3, 1506-4 (or one or more portions/strips of conductive fabric) of a headphone cushion 1508. In some embodiments, the electrode may sit behind the conductive fabric integrated into a headphone ear cushion or ear pad. In some embodiments, on or in the ear cushion there are conductive strips of fabric 1506-1, . . . 1506-4 connected to non-conductive portions of the ear cushion 1508 such that each conductive strip of fabric is not touching another adjacent conductive strip of fabric, and so that each conductive strip of fabric is electrically insulated from each other, and each strip of conductive fabric is connected to a distinct respective electrode such that the signal from each respective electrode can be distinguished from a neighboring electrode because the electrodes remain electrically insulated from each other. In some embodiments an electrode may be electrically connected to the conductive fabric such that the EEG, EMG, and/or other signals may be detected by the electrode through contact between the user's skin and the conductive fabric. In various embodiments, the electrodes are integrated behind the ear cushion on the headphones, and each of the respective electrodes are each in electrical contact with the each of the respective conductive fabrics of the ear cushion. In various embodiments, the electrodes are integrated into the ear cushion of the headphones, with the respective electrodes electrically in-contact with the respective islands (e.g. islands because the conductive fabric portions are electrical ‘islands,’ and not electrically in contact with neighboring conductive fabric portions, only electrically in contact with the sensor electrode) of conductive textile integrated into the outer material of the ear cup or ear cushion of the head phones that are positioned such that the conductive textile would make contact with the user's skin when wearing the headphones. It is understood that the conductive fabric could be a conductive textile, a conductive cloth, a conductive textile, a conductive yarn, a conductive fiber, a conductive foam, a conductive membrane, a conductive flexible conformal material, a conductive polymer, and/or a conductive polymer coated fabric and/or combinations thereof. In some embodiments the ear cushion of the headphones is made out of a rubberized type material, like silicone or thermoplastic urethane (TPU), in which case the electrodes may make contact with the user's skin through conductive polymer, or conductive wires or fibers that are integrated into the silicone or TPU material or other type of flexible conductive conformal material. It is understood that the electrodes can be integrated into the ear cup, ear cushion, Ear-Pads, earpads, ear-canal-probe, earbud, or other part of the headphones that make contact with a user's skin in or around the user's ear. In various embodiments, between the conductive fabric electrodes 1506-1, 1506-2, . . . 1506-4 of the earcup 1508, there are non-conductive portions of the earcup 1508. The non-conductive portions of the earcup 1508 spaced in-between each conductive fabric portion 1506-1 . . . 1506-4 of the earcup 1508, help ensure that each respective electrode remains electrically isolated from its neighboring electrode. According to one embodiment, one or more electrodes are placed at a location on the headphones 1510 that results in a proximate alignment of the one or more electrodes with a location at which the user's jawbone is substantially close to the user's ear when the user wears the headphones 1510. Another placement of one or more electrodes on the headphones 1510 may result in a proximate alignment of the one or more electrodes with an area directly behind the user's ear when the user wears the headphones 1510. Another placement of one or more electrodes on the headphones 1510 may result in an approximate alignment with the user's temple. Another placement of one or more electrodes on the headphones 1510 may result in an approximate alignment with the user's mastoid. Another placement of one or more electrodes on the headphones 1510 may result in an approximate alignment of the electrodes with the user's temporomandibular joint area. According to various embodiments, all the electrode sensors 1504-1 . . . 1504-7 . . . on the headphones 1510 may be situated behind a conductive fabric 1506-1, 1506-2, 1506-3, 1506-4 that covers one or more portions of a respective the ear cuff cushion(s) 1508 and are electrically connected to the respective conductive portions of the ear cuff cushions. According to various embodiments, an electrode(s) may span at least 10%, at least 150%, at least 30%, at least 40%, at least 50%, at least 60%, at least 70%, at least 80%, at least 90%, at least 100%, or more of the width of the ear cuff cushion 1508.

It is understood that a subset of the conductive fabric 1506-1, 1506-2, 1506-3, 1506-4 illustrated in FIG. 15B are accompanied by a corresponding reference numeral. It is further understood that one or more features illustrated in FIG. 15B that are similar in appearance to the conductive fabric 1506-1, 1506-2, 1506-3, 1506-4 may also be interpreted as representing additional conductive fabric (or additional portions of conductive fabric). It is understood that the electrode sensors 1504-1, . . . 1504-7 could be distinct from the conductive fabric and made to be in electrical contact. In other embodiments the electrode sensors 1504-1, . . . 1504-7 could be seamlessly integrated with the conductive fabric portions 1506-1, . . . 1506-4.

One or more embodiments is shown in FIG. 15E, showing Headphones 1510 with EEG and EMG Electrodes integrated into the ear cushion. The headband 1525 of the headphones 1510, connects to the case 1528 of the headphones 1510. The headphones 1510 may contain a circuit board 1531, which may include associated ports (e.g. charging port), input/output ports or antennae (e.g. 3.5 mm audio port, microphone, or Bluetooth antennae, WiFi antennae) and user interface/control buttons (e.g. volume button, play/pause button) that align and connect properly with the case 1528, along with typical circuit board architectures like memory, and processors. The headphones 1510 may also contain speaker 1534 or system that emits sound. The headphones 1510 may also contain the ear cushion 1537 with integrated electrodes 1541-1, 1541-2, 1541-3, 1541-4, 1541.5. It is understood that a subset of the conductive fabric electrodes 1541-1, 1541-2, 1541-3, 1541-4, and 1541-5 integrated into the ear cushion illustrated in FIG. 15D are accompanied by a corresponding reference numeral. It is further understood that one or more features illustrated in FIG. 15E that are similar in appearance to conductive fabric electrodes 1541-1, 1541-2, 1541-3, 1541-4, and 1541-5 integrated into the ear cushion may also be interpreted as representing additional conductive fabric electrodes integrated into the ear cushion.

As shown in FIG. 15C, a non-conductive textile covering may be a top layer portion of an ear cuff cushion 1508. A portion of the non-conductive textile covering of the ear cuff cushion 1508, may be conductive fabric 1512 that may further be integrated into the textile covering, whereby the portion of the conductive fabric 1512 aligns with a respective electrode underneath or inside the ear cushion 1508. As shown in FIG. 15C, the textile covering is a non-conductive fabric or material, with conductive fabric/materials 1512 integrated therein. In various embodiments conductive fibers or materials are integrated into the ear cuff cushion through weaving, sewing, stitching, gluing, extruding, snapping, sliding, clasping, buttons, fasteners, grommets, eyelets, or any number of other methods.

It is understood that while conventional systems rely on electrodes placed at various locations on the top of a person's head, various embodiments described herein provide for the generation and output of meaningful data by electrodes placed solely near, in, and/or around a person's ears, such as substantially near a mastoid area, the occipital area behind the ear, the zygomatic region near the ear, the temporal region, the parotid-masseteric region, the auricular region, the temporomandibular joint area, the temple area, the sphenoid area, in the ear canal, and/or any defined facial region or head region in or around the ear, especially those areas that may be normally touched by a pair of headphones. While having additional electrodes in other areas of the face like the oral region or mental region, or parietal region or occipital region may be helpful for additional data for analysis, placing electrodes in those areas may be uncomfortable for users, and inhibit wearing or using of such devices, are visually unappealing, and may have social/societal issues using such devices in public. In various embodiments, the electrodes are integrated into the headphones in such a way as to be nearly invisible to an outside observer who will see ‘normal-looking’ headphones, and are integrated into headphones in such a way as to be comfortable for long-term wear, allowing a user to comfortably use the headphones for many hours continuously without needing or wanting to take them off. As shown in FIG. 15D, a diagram 1514 includes a left ear headphone diagram 1516 with one or more electrode locations 1, 15, 3, 4, 5, 6, 7, 8, 9 and 10. The diagram 1514 further includes a right ear headphone diagram 1518 with one or more electrode locations 11, 12, 13, 14, 15, 16, 17, 18, 19 and 20. Electrode location 1, 15, 3 and 18, 19, 20 are situated such that corresponding electrodes will be in substantial alignment near a mastoid area behind the right and left ear of a user when the user wears the headphones.

The headphones 1510 may include one or more electrodes that can detect various types of signals, such as EEG and/or EMG signals. For example, one or more electrodes may detect EEG signals. In addition, one or more electrodes may detect EMG signals representing a movement of a user's facial muscle(s) when the user wears the set of headphones. In various embodiments the same electrode may be able to detect EEG, EMG, and ECG signals. In various embodiments the user can use certain facial gestures to interact with a computing device. For example, detection of one or more detected facial muscle movements and/or detected audible clicks caused by teeth movement and/or contact between various teeth may be mapped to an “interaction(s).” An interaction(s) may be processed as representative of a unit(s) and/or occurrence of user input whereby detected movements may be used to control a computing device(s) or define input for the computing device. For example, an interaction(s) may be defined as being mapped to a certain type and/or pattern of facial muscle movement(s) and correspond to one or more input commands to trigger one or more computing device actions.

According to various embodiments, an interaction(s) may emulate a user action applied to a peripheral input device (e.g. a mouse click). For a certain facial gesture(s), such as a smile for example, a preceding interaction may be defined as being required to occur prior to the smile within a duration of time. As such, the preceding interaction may emulate a request for a wake command in which a computing device is instructed to expect to receive a subsequent command. By implementing the requirement of the preceding wake request interaction before the occurrence of a smile, various embodiments may discern whether a smile is a coincidental physical action or a gesture performed by the user that is mapped to a wake request interaction intended to emulate input for the computing device.

According to various embodiments, a detected interaction(s) may be based on the occurrence and/or a sound of a sequence of teeth clicks (such as a double tooth click). For example, a sequence of teeth clicks may be mapped to represent a wake request interaction, which may be followed by a smile. The wake request interaction thereby corresponds to a wake command to trigger the computing device to monitor for an occurrence of at least one subsequent input for a defined period of time. Because the wake command alerts the computing device to expect a subsequent command, the detected smile will be determined to be an interaction that maps to a subsequent input command, rather than a coincidence. Similarly certain facial gestures like a jaw clench may be difficult to for the Analytics Engine to distinguish if the user is intending to perform an interaction based on the jaw-clench interaction or if the user is simply chewing. To address this issue, according to various embodiments, a sleep request interaction may correspond to a sleep command to trigger the computing device to ignore subsequent detected facial gestures. For example, a detected interaction based on a head-nod-simultaneous-to-a-blink may represent a sleep command, which may be followed by chewing. Because the sleep command alerted the computing device to ignore subsequent facial gestures, the device may ignore the user's subsequent chewing rather than trying to determine if the user is attempting to perform an interaction. For example, a detected interaction based on a pre-defined type or pattern of jaw movement may represent a type of command and/or user input.

FIG. 16 is flowchart of an example of a technique 1600 for providing a hearable interface. The technique 1600 includes playing 1602 multiple sounds corresponding to respective menu options on at least one of a left speaker of headphones and a right speaker of the headphones using a spatial audio algorithm to simulate a distinct respective direction of arrival for each of the multiple sounds; detecting 1604 a motion of the headphones; and selecting 1606 one of the respective menu options based on comparison of a direction of the motion of the headphones to respective directions of arrival of the multiple sounds corresponding to the respective menu options. For example, technique 1600 may be implemented using the system 100 of FIGS. 1A-E. For example, technique 1600 may be implemented using the system 200 of FIGS. 2A-E. For example, technique 1600 may be implemented using the system 300 of FIGS. 3A-E. For example, technique 1600 may be implemented using the system 500 of FIGS. 5A-C. For example, technique 1600 may be implemented using the system 600 of FIG. 6A. For example, technique 1600 may be implemented using the system 630 of FIG. 6B. For example, technique 1600 may be implemented using the system 1500 of FIG. 15A.

The technique 1600 includes playing 1602 multiple sounds corresponding to respective menu options on at least one of a left speaker of headphones (e.g., the headphones 1510) and a right speaker of the headphones using a spatial audio algorithm to simulate a distinct respective direction of arrival for each of the multiple sounds. For example, the spatial algorithm (e.g., Dolby Atmos) may provide 3-D audio effects. In some implementations, the respective menu options are generated using a large language model (e.g., Claude, Llama, ChatGPT, or Gemini). For example, the large language model may use a transformer architecture with an attention mechanism and text embeddings. For example, the respective menu options may include proposed responses to a received message (e.g., a text message or an email) that are generated using a large language model. The sound corresponding to one of these menu options may include an automated reading of a proposed response to the received message. For example, the technique 2400 of FIG. 24 may be used with the technique 1600 to facilitate a reply to a message using a hearable interface.

The technique 1600 includes detecting 1604 a motion of the headphones. For example, the motion of the headphones may be detected 1604 based on sensor data from a motion sensor (e.g., from an inertial measurement unit including an accelerometer and/or a gyroscope). In some implementations, the motion of the headphones is caused by a human tilting a head of the human toward a perceived source of one of the multiple sounds corresponding to a respective menu option that the human wishes to select.

The technique 1600 includes selecting 1606 one of the respective menu options based on comparison of a direction of the motion of the headphones to respective directions of arrival of the multiple sounds corresponding to the respective menu options. For example, a sound corresponding to a first menu option of three choices may be played 1602 with a perceived direction of arrival of 60 degrees left of dead ahead, a second menu option of three choices may be played 1602 with a perceived direction of arrival of 60 degrees right of dead ahead, and a third menu option of three choices may be played 1602 with a perceived direction of arrival of 180 degrees from dead ahead. If the user tilts their head approximately 90 degrees to the right, then the second menu option may be selected 1606 as the menu option with a direction of arrival that is closest to the direction of the motion of the headphones.

In some implementations, additional user input / control data may be collected using electrodes attached to the headphones and used to select 1606 a menu option as the choice of the user. For example, electromyography signals and/or electroencephalography signals may be detected and used in a multimodal sensing arrangement (e.g., using motor imagery algorithms) to select 1606 a menu option. For example, the technique 1800 of FIG. 18 may be implemented as part of selecting 1606 a menu option. For example, the technique 1900 of FIG. 19 may be implemented as part of selecting 1606 a menu option. For example, the technique 2000 of FIG. 20 may be implemented as part of selecting 1606 a menu option. For example, the technique 2100 of FIG. 21 may be implemented as part of selecting 1606 a menu option. In some implementations, special electroencephalography waveforms associated with recognition or selection (e.g., P300 waveforms) may be detected and used with delay information relative to the playout times of the sounds corresponding to the menu options to select 1606 one menu options. For example, the technique 2200 of FIG. 22 may be implemented as part of selecting 1606 a menu option. For example, the technique 2300 of FIG. 23 may be implemented as part of selecting 1606 a menu option. Contributions from these various sensing modalities can be weighted and or otherwise combined in a variety of ways to make the final selection 1606 of the respective menu option.

FIG. 17 is flowchart of an example of a technique 1700 for providing a hearable interface. The technique 1700 includes playing 1702 a first sound corresponding to a first respective menu option on a left speaker of headphones; playing 1704 a second sound corresponding to a second respective menu option on a right speaker of the headphones; detecting 1706 a motion of the headphones; and selecting 1708 between the first respective menu option and the second respective menu option based on classifying a direction of the motion of the headphones as either toward a left side of a human or toward a right side of the human. For example, technique 1700 may be implemented using the system 100 of FIGS. 1A-E. For example, technique 1700 may be implemented using the system 200 of FIGS. 2A-E. For example, technique 1700 may be implemented using the system 300 of FIGS. 3A-E. For example, technique 1700 may be implemented using the system 500 of FIGS. 5A-C. For example, technique 1700 may be implemented using the system 600 of FIG. 6A. For example, technique 1700 may be implemented using the system 630 of FIG. 6B. For example, technique 1700 may be implemented using the system 1500 of FIG. 15A.

The technique 1700 includes playing 1702 a first sound corresponding to a first respective menu option on a left speaker of headphones (e.g., the headphones 1510), and playing 1704 a second sound corresponding to a second respective menu option on a right speaker of the headphones. In some implementations, the first respective menu option and the second respective menu option are generated using a large language model (e.g., Claude, Llama, ChatGPT, or Gemini). For example, the large language model may use a transformer architecture with an attention mechanism and text embeddings. For example, the first respective menu option and the second respective menu option may include proposed responses to a received message (e.g., a text message or an email) that are generated using a large language model. The sound corresponding to one of these menu options may include an automated reading of a proposed response to the received message. For example, the technique 2400 of FIG. 24 may be used with the technique 1600 to facilitate a reply to a message using a hearable interface.

The technique 1700 includes detecting 1706 a motion of the headphones. For example, the motion of the headphones may be detected 1706 based on sensor data from a motion sensor (e.g., from an inertial measurement unit including an accelerometer and/or a gyroscope). In some implementations, the motion of the headphones is caused by the human tilting a head of the human toward the left side of the human or toward the right side of the human.

The technique 1700 includes selecting 1708 between the first respective menu option and the second respective menu option based on classifying a direction of the motion of the headphones as either toward a left side of a human or toward a right side of the human. For example, a tilt of the head (and the headphones) toward the left may result in selecting 1708 the first respective menu option with a corresponding sound that was played through the left speaker. For example, a tilt of the head (and the headphones) toward the right may result in selecting 1708 the second respective menu option with a corresponding sound that was played through the right speaker.

In some implementations, additional user input / control data may be collected using electrodes attached to the headphones and used to select 1708 a menu option as the choice of the user. For example, electromyography signals and/or electroencephalography signals may be detected and used in a multimodal sensing arrangement (e.g., using motor imagery algorithms) to select 1708 a menu option. For example, the technique 1900 of FIG. 19 may be implemented as part of selecting 1708 a menu option. For example, the technique 2100 of FIG. 21 may be implemented as part of selecting 1708 a menu option. In some implementations, special electroencephalography waveforms associated with recognition or selection (e.g., P300 waveforms) may be detected and used with delay information relative to the playout times of the sounds corresponding to the menu options to select 1708 one menu options. For example, the technique 2300 of FIG. 23 may be implemented as part of selecting 1708 a menu option. Contributions from these various sensing modalities can be weighted and or otherwise combined in a variety of ways to make the final selection 1708 of the respective menu option.

FIG. 18 is flowchart of an example of a technique 1800 for providing a hearable interface using electromyography signals. The technique 1800 includes accessing 1802 measurements of electrical potential of a set of electrodes positioned on a head of a human wearing the headphones; determining 1804 an electromyography signal based on measurements of electrical potential of the set of electrodes; detecting 1806 a gesture by the human based on the electromyography signal; and selecting 1808 one of the respective menu options based on comparison of a direction of the gesture to respective directions of arrival of the multiple sounds corresponding to the respective menu options. For example, technique 1800 may be implemented using the system 100 of FIGS. 1A-E. For example, technique 1800 may be implemented using the system 200 of FIGS. 2A-E. For example, technique 1800 may be implemented using the system 300 of FIGS. 3A-E. For example, technique 1800 may be implemented using the system 500 of FIGS. 5A-C. For example, technique 1800 may be implemented using the system 600 of FIG. 6A. For example, technique 1800 may be implemented using the system 630 of FIG. 6B. For example, technique 1800 may be implemented using the system 1500 of FIG. 15A.

FIG. 19 is flowchart of an example of a technique 1900 for providing a hearable interface using electromyography signals. The technique 1900 includes accessing 1902 measurements of electrical potential of a set of electrodes positioned on a head of the human; determining 1904 an electromyography signal based on measurements of electrical potential of the set of electrodes; detecting 1906 a gesture by the human based on the electromyography signal; and selecting 1908 between the first respective menu option and the second respective menu option based on classifying the gesture as associated with the left side of the human or associated with the right side of the human. For example, technique 1900 may be implemented using the system 100 of FIGS. 1A-E. For example, technique 1900 may be implemented using the system 200 of FIGS. 2A-E. For example, technique 1900 may be implemented using the system 300 of FIGS. 3A-E. For example, technique 1900 may be implemented using the system 500 of FIGS. 5A-C. For example, technique 1900 may be implemented using the system 600 of FIG. 6A. For example, technique 1900 may be implemented using the system 630 of FIG. 6B. For example, technique 1900 may be implemented using the system 1500 of FIG. 15A.

FIG. 20 is flowchart of an example of a technique 2000 for providing a hearable interface using electroencephalography signals. The technique 2000 includes accessing 2002 measurements of electrical potential of a set of electrodes positioned on a head of a human wearing the headphones; determining 2004 an electroencephalography signal based on measurements of electrical potential of the set of electrodes; detecting 2006 a gesture by the human based on the electroencephalography signal; and selecting 2008 one of the respective menu options based on comparison of a direction of the gesture to respective directions of arrival of the multiple sounds corresponding to the respective menu options. For example, technique 2000 may be implemented using the system 100 of FIGS. 1A-E. For example, technique 2000 may be implemented using the system 200 of FIGS. 2A-E. For example, technique 2000 may be implemented using the system 300 of FIGS. 3A-E. For example, technique 2000 may be implemented using the system 500 of FIGS. 5A-C. For example, technique 2000 may be implemented using the system 600 of FIG. 6A. For example, technique 2000 may be implemented using the system 630 of FIG. 6B. For example, technique 2000 may be implemented using the system 1500 of FIG. 15A.

The technique 2000 includes accessing 2002 measurements of electrical potential of a set of electrodes (e.g., the electrodes 1541-1, 1541-2, 1541-3, 1541-4, 1541.5) positioned on a head of a human wearing the headphones. For example, the headphones may be over-ear headphones (e.g., the headphones 1510 as depicted in FIGS. 15B-E) with the set of electrodes positioned around earpads of the over-ear headphones. For example, the headphones may include an eartip (e.g., the eartip 400) shaped for insertion in an ear canal with the set of electrodes positioned on an outer surface of the eartip. For example, the eartip may be attached to an earbud device that includes one of the left speaker or the right speaker. In some implementations, accessing 2002 the measurements of electrical potential includes sampling (e.g., at 300 Hz) the electrical potential of a conductors connected to the electrodes in the set of electrodes. For example, the measurements of electrical potential may be accessed 2002 using the signal flow 1300 of FIG. 13. In some implementations, accessing 2002 the measurements of electrical potential includes receiving the measurements of electrical potential of the electrodes via a wireless communications link (e.g. the wireless communications link 650). For example, the measurements of electrical potential may be received using the communications interface 666 of the personal computing device 660.

The technique 2000 includes determining 2004 an electroencephalography signal based on measurements of electrical potential of the set of electrodes. For example, the electroencephalography signal may be determined 2004 using the techniques described in relation to steps 704, 706, and 708 of the technique 700 of FIG. 7.

The technique 2000 includes detecting 2006 a gesture by the human based on the electroencephalography signal. For example, a motor imagery algorithm (e.g., using deep temporal networks) may be used to detect the gesture and to determine the direction of the gesture. In some implementations, the motor imagery algorithm includes performing source localization on the electroencephalography signal using an independent components analysis.

The technique 2000 includes selecting 2008 one of the respective menu options based on comparison of a direction of the gesture to respective directions of arrival of the multiple sounds corresponding to the respective menu options. For example, a sound corresponding to a first menu option of three choices may be played with a perceived direction of arrival of 60 degrees left of dead ahead, a second menu option of three choices may be played with a perceived direction of arrival of 60 degrees right of dead ahead, and a third menu option of three choices may be played with a perceived direction of arrival of 180 degrees from dead ahead. If the user blinks their right eye or imagines reaching out with right hand, then the second menu option may be selected 1606 as the menu option with a direction of arrival that is closest to the direction of the gesture.

FIG. 21 is flowchart of an example of a technique 2100 for providing a hearable interface using electroencephalography signals. The technique 2100 includes accessing 2102 measurements of electrical potential of a set of electrodes positioned on a head of the human; determining 2104 an electroencephalography signal based on measurements of electrical potential of the set of electrodes; detecting 2106 a gesture by the human based on the electroencephalography signal; and selecting 2108 between the first respective menu option and the second respective menu option based on classifying the gesture as associated with the left side of the human or associated with the right side of the human. For example, technique 2100 may be implemented using the system 100 of FIGS. 1A-E. For example, technique 2100 may be implemented using the system 200 of FIGS. 2A-E. For example, technique 2100 may be implemented using the system 300 of FIGS. 3A-E. For example, technique 2100 may be implemented using the system 500 of FIGS. 5A-C. For example, technique 2100 may be implemented using the system 600 of FIG. 6A. For example, technique 2100 may be implemented using the system 630 of FIG. 6B. For example, technique 2100 may be implemented using the system 1500 of FIG. 15A.

The technique 2100 includes accessing 2102 measurements of electrical potential of a set of electrodes (e.g., the electrodes 410, 412, 414, and 416) positioned on a head of the human. For example, the headphones may be over-ear headphones (e.g., the headphones 1510 as depicted in FIGS. 15B-E) with the set of electrodes positioned around earpads of the over-ear headphones. For example, the headphones may include an eartip (e.g., the eartip 400) shaped for insertion in an ear canal with the set of electrodes positioned on an outer surface of the eartip. For example, the eartip may be attached to an earbud device that includes one of the left speaker or the right speaker. In some implementations, accessing 2102 the measurements of electrical potential includes sampling (e.g., at 300 Hz) the electrical potential of a conductors connected to the electrodes in the set of electrodes. For example, the measurements of electrical potential may be accessed 2102 using the signal flow 1300 of FIG. 13. In some implementations, accessing 2102 the measurements of electrical potential includes receiving the measurements of electrical potential of the electrodes via a wireless communications link (e.g. the wireless communications link 650). For example, the measurements of electrical potential may be received using the communications interface 666 of the personal computing device 660.

The technique 2100 includes determining 2104 an electroencephalography signal based on measurements of electrical potential of the set of electrodes. For example, the electroencephalography signal may be determined 2104 using the techniques described in relation to steps 704, 706, and 708 of the technique 700 of FIG. 7.

The technique 2100 includes detecting 2106 a gesture by the human based on the electroencephalography signal. For example, a motor imagery algorithm (e.g., using deep temporal networks) may be used to detect the gesture and to determine the direction of the gesture. In some implementations, the motor imagery algorithm includes performing source localization on the electroencephalography signal using an independent components analysis.

The technique 2100 includes selecting 2108 between the first respective menu option and the second respective menu option based on classifying the gesture as associated with the left side of the human or associated with the right side of the human. For example, a blink of the left eye or imagining reaching out with the left hand may result in selecting 2108 the first respective menu option with a corresponding sound that was played through the left speaker. For example, a blink of the right eye or imagining reaching out with the right hand may result in selecting 2108 the second respective menu option with a corresponding sound that was played through the right speaker.

FIG. 22 is flowchart of an example of a technique 2200 for providing a hearable interface using P300 waveforms detected in electroencephalography signals. The technique 2200 includes accessing 2202 measurements of electrical potential of a set of electrodes positioned on a head of a human wearing the headphones; determining 2204 an electroencephalography signal based on measurements of electrical potential of the set of electrodes; detecting 2206 a P300 waveform in the electroencephalography signal; and selecting 2208 one of the respective menu options based on a delay relative to respective playout times of the multiple sounds corresponding to the respective menu options. For example, technique 2200 may be implemented using the system 100 of FIGS. 1A-E. For example, technique 2200 may be implemented using the system 200 of FIGS. 2A-E. For example, technique 2200 may be implemented using the system 300 of FIGS. 3A-E. For example, technique 2200 may be implemented using the system 500 of FIGS. 5A-C. For example, technique 2200 may be implemented using the system 600 of FIG. 6A. For example, technique 2200 may be implemented using the system 630 of FIG. 6B. For example, technique 2200 may be implemented using the system 1500 of FIG. 15A.

FIG. 23 is flowchart of an example of a technique 2300 for providing a hearable interface using P300 waveforms detected in electroencephalography signals. The technique 2300 includes accessing 2302 measurements of electrical potential of a set of electrodes positioned on a head of the human; determining 2304 an electroencephalography signal based on measurements of electrical potential of the set of electrodes; detecting 2306 a P300 waveform in the electroencephalography signal; and selecting 2308 between the first respective menu option and the second respective menu option based on a delay relative to respective playout times of the first sound and the second sound. For example, technique 2300 may be implemented using the system 100 of FIGS. 1A-E. For example, technique 2300 may be implemented using the system 200 of FIGS. 2A-E. For example, technique 2300 may be implemented using the system 300 of FIGS. 3A-E. For example, technique 2300 may be implemented using the system 500 of FIGS. 5A-C. For example, technique 2300 may be implemented using the system 600 of FIG. 6A. For example, technique 2300 may be implemented using the system 630 of FIG. 6B. For example, technique 2300 may be implemented using the system 1500 of FIG. 15A.

FIG. 24 is flowchart of an example of a technique 2400 for responding to a received message using a hearable interface. The technique 2400 includes playing 2402 a received message on at least one of the left speaker and the right speaker; and transmitting 2404 a proposed response to the received message associated with a selected menu option. For example, technique 2400 may be implemented using the system 100 of FIGS. 1A-E. For example, technique 2400 may be implemented using the system 200 of FIGS. 2A-E. For example, technique 2400 may be implemented using the system 300 of FIGS. 3A-E. For example, technique 2400 may be implemented using the system 500 of FIGS. 5A-C. For example, technique 2400 may be implemented using the system 600 of FIG. 6A. For example, technique 2400 may be implemented using the system 630 of FIG. 6B. For example, technique 2400 may be implemented using the system 1500 of FIG. 15A.

The technique 2400 includes playing 2402 a received message on at least one of the left speaker and the right speaker. For example, the received message may be a SMS text message, an email, a voice mail, or a Slack message. Written messages, such a text messages, may be converted to audio using a speech synthesis algorithm to be played 2402 via the left speaker and/or the right speaker.

The technique 1600 of FIG. 16 or the technique 1700 of FIG. 17 may then be used to present options for reply to the received message to user in a hearable interface using the headphones (e.g., the headphones 1510). The respective menu options (e.g., the first respective menu option and the second respective menu option) may include proposed responses to the received message. For example, the respective menu options (e.g., the first respective menu option and the second respective menu option), including the proposed responses, may be generated using a large language model generated using a large language model (e.g., Claude, Llama, ChatGPT, or Gemini). The proposed responses may also be converted to audio using a speech synthesis algorithm to be played via the left speaker and/or the right speaker as part of the technique 1600 or the technique 1700.

When the user selects one of the menu options using the hearable interface enabled using the technique 1600 or the technique 1700, then the technique 2400 includes transmitting 2404 (e.g., in a reply message sent via the same channel in which the received message arrived) a proposed response to the received message that is associated with the selected menu option.

Disclosed herein are implementations of hearable interfaces.

In a first aspect, the subject matter described in this specification can be embodied in systems that include: headphones configured to position a left speaker near a left ear and a right speaker near a right ear when worn by a human, a motion sensor attached to the headphones, and a processing apparatus configured to: play multiple sounds corresponding to respective menu options on at least one of the left speaker and the right speaker using a spatial audio algorithm to simulate a distinct respective direction of arrival for each of the multiple sounds; detect a motion of the headphones based on sensor data from the motion sensor; and select one of the respective menu options based on comparison of a direction of the motion of the headphones to respective directions of arrival of the multiple sounds corresponding to the respective menu options. In the first aspect, the systems may include a set of electrodes attached to the headphones, wherein the headphones are configured to position the set of electrodes on a head of the human; and the processing apparatus may be configured to: access measurements of electrical potential of the set of electrodes; determine an electromyography signal based on measurements of electrical potential of the set of electrodes; detect a gesture by the human based on the electromyography signal; and select one of the respective menu options based on comparison of a direction of the gesture to respective directions of arrival of the multiple sounds corresponding to the respective menu options. In the first aspect, the systems may include a set of electrodes attached to the headphones, wherein the headphones are configured to position the set of electrodes on a head of the human; and the processing apparatus may be configured to: access measurements of electrical potential of the set of electrodes; determine an electroencephalography signal based on measurements of electrical potential of the set of electrodes; detect a gesture by the human based on the electroencephalography signal; and select one of the respective menu options based on comparison of a direction of the gesture to respective directions of arrival of the multiple sounds corresponding to the respective menu options. In the first aspect, a motor imagery algorithm may be used to detect the gesture and to determine the direction of the gesture. In the first aspect, the motor imagery algorithm may include performing source localization on the electroencephalography signal using an independent components analysis. In the first aspect, the systems may include a set of electrodes attached to the headphones, wherein the headphones are configured to position the set of electrodes on a head of the human; and the processing apparatus may be configured to: access measurements of electrical potential of the set of electrodes; determine an electroencephalography signal based on measurements of electrical potential of the set of electrodes; detect a P300 waveform in the electroencephalography signal; and select one of the respective menu options based on a delay relative to respective playout times of the multiple sounds corresponding to the respective menu options. In the first aspect, the headphones may be over-ear headphones with the set of electrodes positioned around earpads of the over-ear headphones. In the first aspect, the headphones may include an eartip shaped for insertion in an ear canal with the set of electrodes positioned on an outer surface of the eartip. In the first aspect, the eartip may be attached to an earbud device that includes one of the left speaker or the right speaker. In the first aspect, the respective menu options are generated using a large language model. In the first aspect, the processing apparatus may be configured to play a received message on at least one of the left speaker and the right speaker, and in which the respective menu options include proposed responses to the received message.

In a second aspect, the subject matter described in this specification can be embodied in methods that include playing multiple sounds corresponding to respective menu options on at least one of a left speaker of headphones and a right speaker of the headphones using a spatial audio algorithm to simulate a distinct respective direction of arrival for each of the multiple sounds; detecting a motion of the headphones; and selecting one of the respective menu options based on comparison of a direction of the motion of the headphones to respective directions of arrival of the multiple sounds corresponding to the respective menu options. In the second aspect, the motion of the headphones is caused by a human tilting a head of the human toward a left side of the human or toward a right side of the human. In the second aspect, the methods may include accessing measurements of electrical potential of a set of electrodes positioned on a head of a human wearing the headphones; determining an electromyography signal based on measurements of electrical potential of the set of electrodes; detecting a gesture by the human based on the electromyography signal; and selecting one of the respective menu options based on comparison of a direction of the gesture to respective directions of arrival of the multiple sounds corresponding to the respective menu options. In the second aspect, the methods may include accessing measurements of electrical potential of a set of electrodes positioned on a head of a human wearing the headphones; determining an electroencephalography signal based on measurements of electrical potential of the set of electrodes; detecting a gesture by the human based on the electroencephalography signal; and selecting one of the respective menu options based on comparison of a direction of the gesture to respective directions of arrival of the multiple sounds corresponding to the respective menu options. In the second aspect, a motor imagery algorithm may be used to detect the gesture and to determine the direction of the gesture. In the second aspect, the motor imagery algorithm may include performing source localization on the electroencephalography signal using an independent components analysis. In the second aspect, the methods may include accessing measurements of electrical potential of a set of electrodes positioned on a head of a human wearing the headphones; determining an electroencephalography signal based on measurements of electrical potential of the set of electrodes; detecting a P300 waveform in the electroencephalography signal; and selecting one of the respective menu options based on a delay relative to respective playout times of the multiple sounds corresponding to the respective menu options. In the second aspect, the respective menu options are generated using a large language model. In the second aspect, the methods may include playing a received message on at least one of the left speaker and the right speaker, and in which the respective menu options include proposed responses to the received message.

In a third aspect, the subject matter described in this specification can be embodied in systems that include: headphones configured to position a left speaker near a left ear and a right speaker near a right ear when worn by a human, a motion sensor attached to the headphones, and a processing apparatus configured to: play a first sound corresponding to a first respective menu option on the left speaker; play a second sound corresponding to a second respective menu option on the right speaker; detect a motion of the headphones based on sensor data from the motion sensor; and select between the first respective menu option and the second respective menu option based on classifying a direction of the motion of the headphones as either toward a left side of the human or toward a right side of the human. In the third aspect, the motion of the headphones may be caused by the human tilting a head of the human toward the left side of the human or toward the right side of the human. In the third aspect, the systems may include a set of electrodes attached to the headphones, wherein the headphones are configured to position the set of electrodes on a head of the human; and the processing apparatus may be configured to: access measurements of electrical potential of the set of electrodes; determine an electromyography signal based on measurements of electrical potential of the set of electrodes; detect a gesture by the human based on the electromyography signal; and select between the first respective menu option and the second respective menu option based on classifying the gesture as associated with the left side of the human or associated with the right side of the human. In the third aspect, the systems may include a set of electrodes attached to the headphones, wherein the headphones are configured to position the set of electrodes on a head of the human; and the processing apparatus may be configured to: access measurements of electrical potential of the set of electrodes; determine an electroencephalography signal based on measurements of electrical potential of the set of electrodes; detect a gesture by the human based on the electroencephalography signal; and select between the first respective menu option and the second respective menu option based on classifying the gesture as associated with the left side of the human or associated with the right side of the human. In the third aspect, a motor imagery algorithm may be used to detect the gesture and to determine which side of the human the gesture is associated with. In the third aspect, the motor imagery algorithm may include performing source localization on the electroencephalography signal using an independent components analysis. In the third aspect, the systems may include a set of electrodes attached to the headphones, wherein the headphones are configured to position the set of electrodes on a head of the human; and the processing apparatus may be configured to: access measurements of electrical potential of the set of electrodes; determine an electroencephalography signal based on measurements of electrical potential of the set of electrodes; detect a P300 waveform in the electroencephalography signal; and select between the first respective menu option and the second respective menu option based on a delay relative to respective playout times of the first sound and the second sound. In the third aspect, the headphones are over-ear headphones with the set of electrodes positioned around earpads of the over-ear headphones. In the third aspect, the headphones may include an eartip shaped for insertion in an ear canal with the set of electrodes positioned on an outer surface of the eartip. In the third aspect, the eartip may be attached to an earbud device that includes one of the left speaker or the right speaker. the first respective menu option and the second respective menu option are generated using a large language model. In the third aspect, the processing apparatus is configured to play a received message on at least one of the left speaker and the right speaker, and in which the first respective menu option and the second respective menu option include proposed responses to the received message.

In a fourth aspect, the subject matter described in this specification can be embodied in methods that include playing a first sound corresponding to a first respective menu option on a left speaker of headphones; playing a second sound corresponding to a second respective menu option on a right speaker of the headphones; detecting a motion of the headphones; and selecting between the first respective menu option and the second respective menu option based on classifying a direction of the motion of the headphones as either toward a left side of a human or toward a right side of the human. In the fourth aspect, the motion of the headphones may be caused by the human tilting a head of the human toward the left side of the human or toward the right side of the human. In the fourth aspect, the methods may include accessing measurements of electrical potential of a set of electrodes positioned on a head of the human; determining an electromyography signal based on measurements of electrical potential of the set of electrodes; detecting a gesture by the human based on the electromyography signal; and selecting between the first respective menu option and the second respective menu option based on classifying the gesture as associated with the left side of the human or associated with the right side of the human. In the fourth aspect, the methods may include accessing measurements of electrical potential of a set of electrodes positioned on a head of the human; determining an electroencephalography signal based on measurements of electrical potential of the set of electrodes; detecting a gesture by the human based on the electroencephalography signal; and selecting between the first respective menu option and the second respective menu option based on classifying the gesture as associated with the left side of the human or associated with the right side of the human. In the fourth aspect, a motor imagery algorithm may be used to detect the gesture and to determine which side of the human the gesture is associated with. In the fourth aspect, the motor imagery algorithm includes performing source localization on the electroencephalography signal using an independent components analysis. In the fourth aspect, the methods may include accessing measurements of electrical potential of a set of electrodes positioned on a head of the human; determining an electroencephalography signal based on measurements of electrical potential of the set of electrodes; detecting a P300 waveform in the electroencephalography signal; and selecting between the first respective menu option and the second respective menu option based on a delay relative to respective playout times of the first sound and the second sound. In the fourth aspect, the first respective menu option and the second respective menu option may be generated using a large language model. In the fourth aspect, the methods may include playing a received message on at least one of the left speaker and the right speaker, and in which the first respective menu option and the second respective menu option include proposed responses to the received message.

In a fifth aspect, the subject matter described in this specification can be embodied in a non-transitory computer-readable storage medium. The non-transitory computer-readable storage medium may include executable instructions that, when executed by a processor, cause performance of operations, comprising operations to: play multiple sounds corresponding to respective menu options on at least one of a left speaker of headphones and a right speaker of the headphones using a spatial audio algorithm to simulate a distinct respective direction of arrival for each of the multiple sounds; detect a motion of the headphones; and select one of the respective menu options based on comparison of a direction of the motion of the headphones to respective directions of arrival of the multiple sounds corresponding to the respective menu options. In the fifth aspect, the motion of the headphones may be caused by a human tilting a head of the human toward a left side of the human or toward a right side of the human. In the fifth aspect, the operations may comprise operations to: access measurements of electrical potential of a set of electrodes positioned on a head of a human wearing the headphones; determine an electromyography signal based on measurements of electrical potential of the set of electrodes; detect a gesture by the human based on the electromyography signal; and select one of the respective menu options based on comparison of a direction of the gesture to respective directions of arrival of the multiple sounds corresponding to the respective menu options. In the fifth aspect the operations may comprise operations to: access measurements of electrical potential of a set of electrodes positioned on a head of a human wearing the headphones; determine an electroencephalography signal based on measurements of electrical potential of the set of electrodes; detect a gesture by the human based on the electroencephalography signal; and select one of the respective menu options based on comparison of a direction of the gesture to respective directions of arrival of the multiple sounds corresponding to the respective menu options. In the fifth aspect, a motor imagery algorithm may be used to detect the gesture and to determine the direction of the gesture. In the fifth aspect, the motor imagery algorithm may include performing source localization on the electroencephalography signal using an independent components analysis. In the fifth aspect, the operations may comprise operations to: access measurements of electrical potential of a set of electrodes positioned on a head of a human wearing the headphones; determine an electroencephalography signal based on measurements of electrical potential of the set of electrodes; detect a P300 waveform in the electroencephalography signal; and select one of the respective menu options based on a delay relative to respective playout times of the multiple sounds corresponding to the respective menu options. In the fifth aspect, the respective menu options may be generated using a large language model. In the fifth aspect, the operations may comprise operations to: play a received message on at least one of the left speaker and the right speaker, and in which the respective menu options include proposed responses to the received message.

In a sixth aspect, the subject matter described in this specification can be embodied in a non-transitory computer-readable storage medium. The non-transitory computer-readable storage medium may include executable instructions that, when executed by a processor, cause performance of operations, comprising operations to: play a first sound corresponding to a first respective menu option on a left speaker of headphones; play a second sound corresponding to a second respective menu option on a right speaker of the headphones; detect a motion of the headphones; and select between the first respective menu option and the second respective menu option based on classifying a direction of the motion of the headphones as either toward a left side of a human or toward a right side of the human. In the sixth aspect, the motion of the headphones may be caused by the human tilting a head of the human toward the left side of the human or toward the right side of the human. In the sixth aspect, the operations may comprise operations to: access measurements of electrical potential of a set of electrodes positioned on a head of the human; determine an electromyography signal based on measurements of electrical potential of the set of electrodes; detect a gesture by the human based on the electromyography signal; and select between the first respective menu option and the second respective menu option based on classifying the gesture as associated with the left side of the human or associated with the right side of the human. In the sixth aspect, the operations may comprise operations to: access measurements of electrical potential of a set of electrodes positioned on a head of the human; determine an electroencephalography signal based on measurements of electrical potential of the set of electrodes; detect a gesture by the human based on the electroencephalography signal; and select between the first respective menu option and the second respective menu option based on classifying the gesture as associated with the left side of the human or associated with the right side of the human. In the sixth aspect, a motor imagery algorithm may be used to detect the gesture and to determine which side of the human the gesture is associated with. In the sixth aspect, the motor imagery algorithm may include performing source localization on the electroencephalography signal using an independent components analysis. In the sixth aspect, the operations may comprise operations to: access measurements of electrical potential of a set of electrodes positioned on a head of the human; determine an electroencephalography signal based on measurements of electrical potential of the set of electrodes; detect a P300 waveform in the electroencephalography signal; and select between the first respective menu option and the second respective menu option based on a delay relative to respective playout times of the first sound and the second sound. In the sixth aspect, the first respective menu option and the second respective menu option may be generated using a large language model. In the sixth aspect, the operations may comprise operations to: play a received message on at least one of the left speaker and the right speaker, and in which the first respective menu option and the second respective menu option include proposed responses to the received message.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. A system comprising:
headphones configured to position a left speaker near a left ear and a right speaker near a right ear when worn by a human,
a motion sensor attached to the headphones, and
a processing apparatus configured to:
play a first sound corresponding to a first respective menu option on the left speaker;
play a second sound corresponding to a second respective menu option on the right speaker;
detect a motion of the headphones based on sensor data from the motion sensor; and
select between the first respective menu option and the second respective menu option based on classifying a direction of the motion of the headphones as either toward a left side of the human or toward a right side of the human.

2. The system of claim 1, in which the motion of the headphones is caused by the human tilting a head of the human toward the left side of the human or toward the right side of the human.

3. The system of claim 1, comprising:
a set of electrodes attached to the headphones, wherein the headphones are configured to position the set of electrodes on a head of the human; and
wherein the processing apparatus is configured to:
access measurements of electrical potential of the set of electrodes;
determine an electromyography signal based on measurements of electrical potential of the set of electrodes;
detect a gesture by the human based on the electromyography signal; and
select between the first respective menu option and the second respective menu option based on classifying the gesture as associated with the left side of the human or associated with the right side of the human.

4. The system of claim 1, comprising:
a set of electrodes attached to the headphones, wherein the headphones are configured to position the set of electrodes on a head of the human; and
wherein the processing apparatus is configured to:
access measurements of electrical potential of the set of electrodes;
determine an electroencephalography signal based on measurements of electrical potential of the set of electrodes;
detect a gesture by the human based on the electroencephalography signal; and
select between the first respective menu option and the second respective menu option based on classifying the gesture as associated with the left side of the human or associated with the right side of the human.

5. The system of claim 4, in which a motor imagery algorithm is used to detect the gesture and to determine which side of the human the gesture is associated with.

6. The system of claim 5, in which the motor imagery algorithm includes performing source localization on the electroencephalography signal using an independent components analysis.

7. The system of claim 1, comprising:
a set of electrodes attached to the headphones, wherein the headphones are configured to position the set of electrodes on a head of the human; and
wherein the processing apparatus is configured to:
access measurements of electrical potential of the set of electrodes;
determine an electroencephalography signal based on measurements of electrical potential of the set of electrodes;
detect a P300 waveform in the electroencephalography signal; and
select between the first respective menu option and the second respective menu option based on a delay relative to respective playout times of the first sound and the second sound.

8. The system of claim 7, in which the headphones are over-ear headphones with the set of electrodes positioned around earpads of the over-ear headphones.

9. The system of claim 7, in which the headphones include an eartip shaped for insertion in an ear canal with the set of electrodes positioned on an outer surface of the eartip.

10. The system of claim 9, in which the eartip is attached to an earbud device that includes one of the left speaker or the right speaker.

11. The system of claim 1, in which the first respective menu option and the second respective menu option are generated using a large language model.

12. The system of claim 11, in which the processing apparatus is configured to play a received message on at least one of the left speaker and the right speaker, and in which the first respective menu option and the second respective menu option include proposed responses to the received message.

13. A system comprising:
headphones configured to position a left speaker near a left ear and a right speaker near a right ear when worn by a human,
a motion sensor attached to the headphones, and
a processing apparatus configured to:
play multiple sounds corresponding to respective menu options on at least one of the left speaker and the right speaker using a spatial audio algorithm to simulate a distinct respective direction of arrival for each of the multiple sounds;
detect a motion of the headphones based on sensor data from the motion sensor; and
select one of the respective menu options based on comparison of a direction of the motion of the headphones to respective directions of arrival of the multiple sounds corresponding to the respective menu options.

14. The system of claim 13, comprising:
a set of electrodes attached to the headphones, wherein the headphones are configured to position the set of electrodes on a head of the human; and
wherein the processing apparatus is configured to:
access measurements of electrical potential of the set of electrodes;
determine an electromyography signal based on measurements of electrical potential of the set of electrodes;
detect a gesture by the human based on the electromyography signal; and
select one of the respective menu options based on comparison of a direction of the gesture to respective directions of arrival of the multiple sounds corresponding to the respective menu options.

15. The system of claim 13, comprising:
a set of electrodes attached to the headphones, wherein the headphones are configured to position the set of electrodes on a head of the human; and
wherein the processing apparatus is configured to:
access measurements of electrical potential of the set of electrodes;
determine an electroencephalography signal based on measurements of electrical potential of the set of electrodes;
detect a gesture by the human based on the electroencephalography signal; and
select one of the respective menu options based on comparison of a direction of the gesture to respective directions of arrival of the multiple sounds corresponding to the respective menu options.

16. The system of claim 15, in which a motor imagery algorithm is used to detect the gesture and to determine the direction of the gesture.

17. The system of claim 16, in which the motor imagery algorithm includes performing source localization on the electroencephalography signal using an independent components analysis.

18. The system of claim 13, comprising:
a set of electrodes attached to the headphones, wherein the headphones are configured to position the set of electrodes on a head of the human; and
wherein the processing apparatus is configured to:
access measurements of electrical potential of the set of electrodes;
determine an electroencephalography signal based on measurements of electrical potential of the set of electrodes;
detect a P300 waveform in the electroencephalography signal; and
select one of the respective menu options based on a delay relative to respective playout times of the multiple sounds corresponding to the respective menu options.

19. The system of claim 13, in which the respective menu options are generated using a large language model.

20. The system of claim 19, in which the processing apparatus is configured to play a received message on at least one of the left speaker and the right speaker, and in which the respective menu options include proposed responses to the received message.
